(19) United States
(12) Patent Application Publication
(10) Pub. No.: US 2005/0246641 A1
(43) Pub. Date: Nov. 3, 2005

(54) Recording apparatus, computer-readable program, and system lsi

(76) Inventors: Ryuichi Hori, HIROSHIMA (JP); Shuji Okamoto, Kure (JP)

Correspondence Address: WENDEROTH, LIND & PONACK, L.L.P., 2033 K STREET N. W., SUITE 800, WASHINGTON, DC, 20006-1021, US

(21) Appl. No.: 10/506,786

(22) PCT Filed: Dec. 11, 2003
(86) PCT No.: PCT/JP03/15829

§ 371 Date: Sep. 7, 2004

(30) Foreign Application Priority Data
Dec. 11, 2002 (JP) 2002-359866

(51) Int. Cl. G06F 3/00; G06F 9/00; G11B 27/00; G06F 17/00

(52) U.S. Cl. 715/723; 715/704

(57) ABSTRACT

Provided is a recording apparatus that prompts a user to judge whether non-referenced part in a DVD should be deleted or not, thereby facilitating cleanup of recorded contents in the DVD. A playlist editing unit (15) obtains a PL by performing a playlist editing, where the playlist is a logical playback path defined on a VOB recorded in the DVD and contains at least one playback section defined by the user. After the playlist editing is performed, a non-referenced part extraction unit (17) displays to the user a plurality of remaining parts resulting after subtracting from the entire VOB the playback section specified by PL information, as a plurality of non-referenced parts in a moving image stream. A substantial editing unit (18) deletes any of the displayed non-referenced parts, according to a user operation.

### TECHNICAL FIELD

The present invention relates to a recording apparatus such as a DVD recorder, a computer-readable program, and a system LSI, that are for recording moving image streams in a recording medium to which random access is allowed. The present invention particularly relates to improvement in performing editing processes relating to the moving image streams recorded in a recording medium.

### BACKGROUND ART

Each manufacturer, in expectation of users' demand for DVD recorders to replace their VTRs, started to introduce recording apparatuses equipped with various additional functions. A representative example of such additional functions is editing functions directed to playlist.

The playlist (PL) is a logical playback path defined for a moving image stream recorded in a DVD, and includes one or more playback sections defined by a user.

The conventional playlist editing for a playlist having the mentioned structure is composed of: a process of defining playback sections to be included in a playlist; and an order-assigning process for the playback sections.

In the process of defining playback sections, a GUI for receiving editing operation for a moving image stream is displayed, so as to receive, from a user, specification as to from which point the user wants to start playback of the moving image stream (playback starting point), and which point the user wants to end the playback (playback ending point). Once the user defines these playback starting/ending points, the pointer information indicating the defined playback starting/ending points is written to a DVD. This pointer information is the playback section information for specifying the playback sections, and the defining process for the playback sections will end with completion of writing this playback section information.

If two or more playback sections are defined in the process of defining playback sections, then the operation for assigning order to the playback sections is received from the user, the order specifically being the playback order in which the playback sections are to be played back. A playback path is defined, by arranging pieces of playback section information that each define a playback section according to the desired playback order.

The DVD prestores a plurality of pieces of playlist information, each showing a playback path. Then, the recording apparatus is able to not only play back the moving image stream that is in the DVD, in the order as it is, but also play back according to any playback paths shown by the pieces of playlist information. The playlist editing enables increase in variation of playback with facility.

One example of the prior arts realizing such playlist editing is listed below as “patent reference 1”.

<Patent Reference 1>

U.S. Pat. No. 6,181,870

Incidentally, after such playlist editing has been repeated, the free-area of the DVD will inevitably decrease, because non-referenced part not used by the playlist will remain in the DVD. The non-referenced part is specifically a remainder after the playback sections constituting the playlist are subtracted from the entire moving image stream. Because the data of the non-referenced part will remain undeleted, another recording is sometimes refused in a DVD. Theoretically, if playback according to the playlist is more and more frequent, with fewer playbacks according to the original moving image stream as it is, all the non-referenced parts should be deleted. However, such a drastic deletion directed to non-referenced parts sometimes causes the user to regret another day, when he realizes the worth of the images in the deleted parts. The user therefore dithers and procrastinates deletion of the non-referenced parts, thinking that someday he might need the parts. This is one cause of lack in free area.

Furthermore, in a case when a plurality of playback paths are defined that have overlapping parts with each other, it is even difficult to understand which part is a non-referenced part, causing the user to be unwilling to organize the contents recorded in the DVD.

### DISCLOSURE OF THE INVENTION

In view of the above-described problem, the object of the present invention is to provide a recording apparatus that prompts a user to judge whether non-referenced part in a recording medium should be deleted or not, thereby facilitating cleanup of recorded contents in the recording medium.

This object is achieved by a recording apparatus that writes a video stream to a recording medium and edits the video stream, the recording apparatus including: an editing unit operable to specify, in accordance with a user operation, a plurality of parts of the video stream as playback sections; a display unit operable to display to the user, a plurality of parts that remain after the playback sections are subtracted from the video stream, as non-referenced parts; and a deletion unit operable to delete at least one of the displayed non-referenced parts from the recording medium, according to a user operation.

When there is a small shortage in free area for recording a new content, enough free area is allocated by deleting some of a plurality of non-referenced parts having been extracted. Accordingly, it prevents losing of an opportunity of recording another broadcast content. In deletion, a plurality of non-referenced parts are displayed to the user, among which the user can choose parts to be deleted. With this construction, it becomes possible to choose some whose preservation value is relatively low from among the displayed non-referenced parts, thereby enabling a new content to be recorded. By doing this, the user will be prevented from regretting over lost contents' portions, and at the same time, new recordings can be realized.

The applicant recognizes the distinguished effect of the present invention over the invention of the patent reference 1. The patent reference 1 discloses a technology for creating cell information in a preparatory process called “virtual editing”, and for performing batch-deletion on images that are out of range specified by the cell information. However the batch-deletion might cause the user to regret, because all the images including those worthy of preservation will be deleted at once. As opposed to this, the present invention offers the user an opportunity of confirming the deletion, by displaying the contents of the non-referenced parts. This enables individual deletion in which only unnecessary non-referenced parts are deleted, while retaining non-referenced parts including valuable images. Therefore, the user will be prevented from regretting.

Here, each of the playback sections maybe represented by a set of starting/ending positions of a playback operation, and the plurality of non-referenced parts may include a part from a front-end of the video stream to immediately before a starting position of one of the playback sections that appears first, and a part from immediately after an ending position of one of the playback sections that appears last to a rear-end of the video stream. In a case where there is no playback section at the front-end or at the rear-end of the video stream, this construction enables extraction of the part from the front-end of the video stream to immediately before the starting position of the first playback section, and the part from immediately after the ending position of the last playback section to the rear-end of the video stream, without performing interactive operation with the user that relates to specification of the mentioned non-referenced parts of the video stream. This enhances the convenience for the user.

More specifically, once such playback sections are specified at a playlist editing, the mentioned non-referenced parts will be identified automatically by referring to this specification. According to this, only an operation of “playback section specification plus non-reference parts selection” enables non-referenced part deletion. This greatly saves time and trouble compared to the conventional procedure in which starting/ending points of each non-referenced part are specified via an interactive operation with the user, the range of deletion is decided, and finally the deletion is performed. Therefore, the user will be more encouraged to delete the non-referenced parts.

Here, the non-referenced parts may include every part immediately after one of the playback sections to immediately before another of the playback sections that follows. With this construction, every gap-part between one of the playback sections and another of the playback sections that follows is also extracted automatically, as non-referenced part. Therefore, this construction saves time and trouble necessary for interactive operation relating to specification of such gap-parts, thereby enabling non-referenced parts to be extracted with facility.

Here, the display performed by the display unit may be one of: sequential playback of a plurality of pieces of picture data included in the non-referenced parts; and disposing, on a screen, of a plurality of thumbnails each corresponding to the pieces of picture data. With this construction, judgment as to whether an image worthy of preservation is included in the non-referenced parts can be instantly performed, thereby accelerating the cleanup of non-referenced parts.

Furthermore, it serves as impetus to prompt the user to decide the deletion, to put the plurality of non-referenced parts existing in the recording medium in an actual display to the user, who has dithered and procrastinated the deletion vacillating over thoughts that he might or might not need these parts in the future.

Here, a plurality of video streams may be written to the recording medium, each stream being classified into two or more contents, and the deletion unit deletes only non-referenced parts included in a certain content.

With this construction, in a case where two or more video streams are classified into one content, the video streams belonging to that content can be collectively deleted. This greatly saves time and trouble compared to the case in which the non-referenced parts are deleted one at a time.

Here, it is also possible that the recording apparatus further includes a reception unit operable to receive, from the user, an operation for programming a recording; and a calculation unit operable to calculate an area size required for the programmed recording, where the display unit performs the display, only if the calculated area size exceeds a free area size of the recording medium, and the display unit further displays a message making an inquiry to the user about whether the non-referenced parts should be deleted. With this construction, display of non-referenced parts will be performed when there is no free area for the programmed recording. Since the user will be prompted to delete the non-referenced parts if the user has noticed the need for free area at the recording programming stage, the cleanup of non-referenced part is facilitated. In addition, the need for abandoning the recording programming can be circumvented.

Here, it is also possible that the recording apparatus further includes a reception unit operable to receive, from the user, specification of an environment setting value, the environment setting value being a minimum free area size that the recording medium should allocate, where the display unit performs the display, only if the calculated area size exceeds a free area size of the recording medium, and the display unit further displays a message making an inquiry to the user about whether the non-referenced parts should be deleted.

With this construction, the user is allowed to set in the recording apparatus the length of broadcast content that the user plans to record in the future. Since the operation of prompting the user to delete the non-referenced parts will be only performed when the free area size of the recording medium falls short of this length, this would leave the user enough time to prepare for the recording of the broadcast content.

Here, it is also possible that the recording apparatus further includes a backup unit operable to record therein a backup of the non-referenced parts, prior to the deletion performed by the deletion unit; an inquiry unit operable, after the deletion performed by the deletion unit, to make an inquiry to the user about whether an undo operation should be performed; and a write back unit operable, if the user's answer to the inquiry is affirmative, to write back the backup recorded in the backup unit to the recording medium.

With this construction, if the user notices the value of the already deleted non-referenced part, the part can be written back to the recording medium, preventing the user to regret over the lost part. In addition, the parts to be recorded as a backup are narrowed to only the part actually deleted. This circumvents increase of memory areas occupied by backups. More specifically, in the real editing described in the patent reference 1 where the batch deletion of a plurality of non-referenced parts is performed, all the non-referenced parts are required to be retained, thereby leading to a great increase in the memory capacity for non-referenced part backup. However, with the playback apparatus according to the present invention, what is needed is a memory capacity sufficient for recording one non-referenced part, thereby preventing enormous increase in memory size of the playback apparatus.

### BRIEF DESCRIPTION OF THE DRAWINGS

FIG. 1 is a diagram showing the contents recorded in the DVD.

FIG. 2 is a diagram showing a PG comprised of a VOB, and one or more pieces of management information regarding the VOB.

FIG. 3 is a diagram showing one example of the PL information created in the playlist editing.

FIG. 4 is a diagram showing, in a case where the PL information shown in FIG. 3 is generated, which part of the VOB sequence can be non-referenced part.

FIG. 5 is a diagram showing the outer appearances of the recording apparatus and the DVD, relating to the present invention.

FIG. 6 is a diagram showing one example of the route menu.

FIG. 7 is a diagram showing one example of the playlist-editing menu.

FIG. 8 is a diagram showing one example of the PG playback menu.

FIG. 9 is a diagram showing one example of the PL playback menu.

FIG. 10 is a diagram showing one example of the substantial editing menu.

FIG. 11 is a diagram showing the internal structure of the recording apparatus.

FIG. 12 is a diagram showing the main routine performed by the application unit 14.

FIG. 13 is a flowchart showing the procedures performed by the playlist editing unit 15.

FIG. 14 is a flowchart showing the procedures performed by the substantial editing unit 18.

FIG. 15A is a diagram showing a case in which the beginning part of the VOB sequence is specified as a cell of any PL.

FIG. 15B is a diagram showing a case in which the beginning part of the VOB sequence is not specified as a cell of any PL.

FIG. 16 is a diagram showing how the repetition of this loop operation specifies non-referenced parts.

FIG. 17A is a diagram showing one example of the case in which the Out-point of the Cell#x coincides with the rear-end of the VOB sequence.

FIG. 17B is a diagram showing one example of the case in which the In-point of the Cell#x coincides with the front-end of the VOB sequence.

FIGS. 18A and 18B are diagrams respectively showing a case in which Steps S38-S44 are repeated.

FIGS. 19A and 19B are diagrams respectively showing a case in which Steps S38-S44 are repeated.

FIG. 20 is a diagram showing a case in which two PLs, namely PL#1 and PL#2 are defined on a VOB sequence.

FIG. 21 is a flowchart showing the procedure performed by the substantial editing unit 18.

FIG. 22 is a flowchart showing the procedure for the batch deletion of the non-referenced parts in the DVD.

FIG. 23 is a diagram showing the PG navigator relating to the second embodiment.

FIG. 24 is a flowchart showing the PG playback relating to the second embodiment.

FIG. 25 is a diagram showing one example of the PG navigator relating to the third embodiment.

FIG. 26 is a flowchart showing the playback process regarding the PG navigator assigned a check box.

FIG. 27 is a diagram showing one example of the picture recording programming menu.

FIG. 28 is a flowchart showing the procedure of the picture recording programming performed according to the menu of FIG. 27.

FIG. 29 is a diagram showing one example of the menu for receiving environment setting.

FIG. 30 is a flowchart showing the main flowchart structured to perform operations according to the environment setting.

FIG. 31 is a flowchart for receiving the operation via the environment settings menu.

FIG. 32 is a flowchart showing the procedure of returning the non-referenced part back to the PlayList.

FIG. 33 is a diagram showing the process in which the non-referenced part #r to be returned to the PlayList is specified.

FIG. 34 is a diagram showing the process in which the non-referenced part #r to be returned to the PlayList is inserted between the cell information #p and the cell information #p+1.

FIG. 35 shows the data structure of a moving image stream to be recorded in a BD-RE, under the same notation system as used in FIG. 3.

FIG. 36 is a diagram showing the non-referenced part of the moving image stream of FIG. 35.

FIG. 37 is a diagram showing a Bridge part.

FIG. 38 is a diagram showing another Bridge part.

### BEST MODE FOR CARRYING OUT THE INVENTION

### First Embodiment

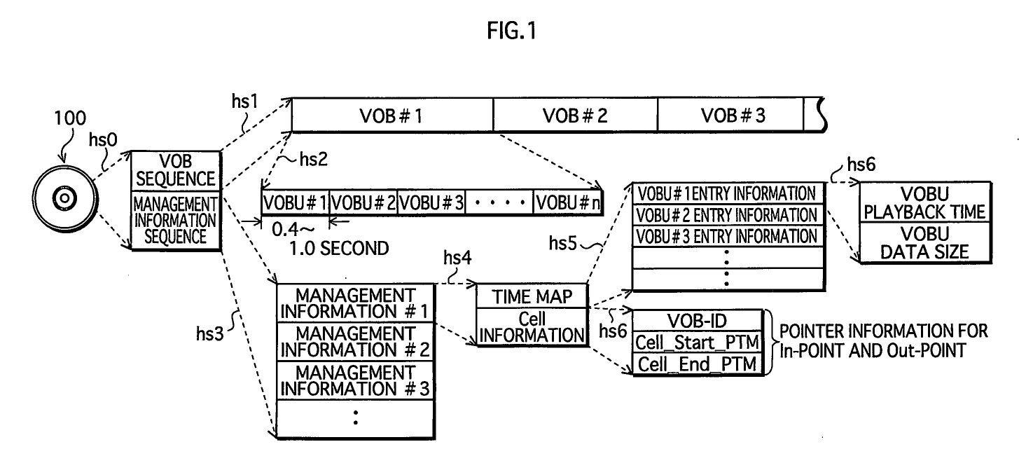

The following explains an embodiment of a recording apparatus that relates to the present invention. Before explaining the recording apparatus of the present invention, an object of editing by the recording apparatus is explained. The object of editing by the recording apparatus is, in other words, a content recorded in a DVD. The content is comprised of one or more VOB (Video Object) s, and management information for each of the VOBs. Such a content is called a PG (ProGram) in the field of DVD. The VOBs and corresponding management information are recorded in a DVD, in accordance with the data structure shown in FIG. 1. FIG. 1 is a diagram showing a content recorded in a DVD. A DVD 100 stores therein a VOB sequence and a management information sequence, as shown by a broken line hs0 in FIG. 1.

The VOB sequence is comprised of a plurality of VOBs (VOB#1, VOB#2, and VOB#3), as shown by a broken line hs1.

The VOB is a moving image stream which is in the MPEG-PS (Program Stream) format, obtained as a result of interleave multiplexing performed in relation to a video stream and an audio stream. The video stream is a plurality of pieces of picture data having been subjected to compression encoding. Each piece of picture data corresponds to one image, and is displayed in a display period of image signal, which is about 33 m seconds. The audio stream is composed of a plurality of audio frames having been subjected to compression encoding.

The VOB obtained by the interleave multiplexing has a structure in which a plurality of VOBUs are arranged chronologically, as shown by the broken arrow line hs2. The VOBU (Video Object Unit) is a minimum decodable unit of VOB, and includes a GOP and a plurality of audio frames to be concurrently played back with this GOP, the GOP being a collection of pieces of picture data each corresponding to 0.4-1.0 second. Playback can be performed from any point if it is the beginning of a VOBU, meaning that the VOB can be randomly accessed, at such a short time interval as 0.4-1.0 second.

Next, the management information sequence is described. The management information sequence is, as shown by the broken arrow line hs3, comprised of a plurality of pieces of management information (i.e. management information #1, #2, and #3) each corresponding to the VOB#1, VOB#2, and VOB#3. Each piece of management information is composed of “time map” and “cell information”, as shown by the broken arrow line hs4.

“Time map” is a reference table used in making indirect reference to the address of each random-accessible position in a VOB, with use of time information. The “Time map” is comprised of pieces of entry information (VOBU#1 entry information, VOBU#2 entry information, VOBU#3 entry information . . . ) each corresponding to a VOBU. In each piece of entry information, “VOBU playback time” showing the time required for playback of the particular VOBU, is corresponded to “VOBU size” showing the size of data for the VOBU. Because of adoption of the variable-length compression encoding method, it is possible to perform random access from an arbitrary playback time to the picture data within the VOBU that corresponds to the particular playback time, even when the size and the playback time of each VOBU including a GOP, vary.

Cell information is pointer information that defines one or more logical playback sections that constitute a PG. The cell information is characterized by the notation system used. In this notation system, a playback section is defined using the time map as a reference table as indirect reference. The reason why cell information is described in indirect reference notation is for eliminating a burden of updating the cell information, incident to editing performed in relation to the VOB. As shown by the leader line hs6, cell information is comprised of: “VOB-ID” of VOB to which the In-point and the Out-point of the VOB belong to; “Cell_Start_PTM” representing a relative time from the front-end of the VOB to the In-point; and “Cell_End_PTM” representing a relative time from the front-end of the VOB to the Out-point. Each VOBU has 0.4-1.0 second time accuracy, whereas these “Cell_StarT_PTM” and “Cell_End_PTM” have 33 m-second time accuracy, which is less than the display period of one image. Accordingly, In-point/Out-point of a cell are represented by a time accuracy used for each piece of picture data belonging to a VOBU.

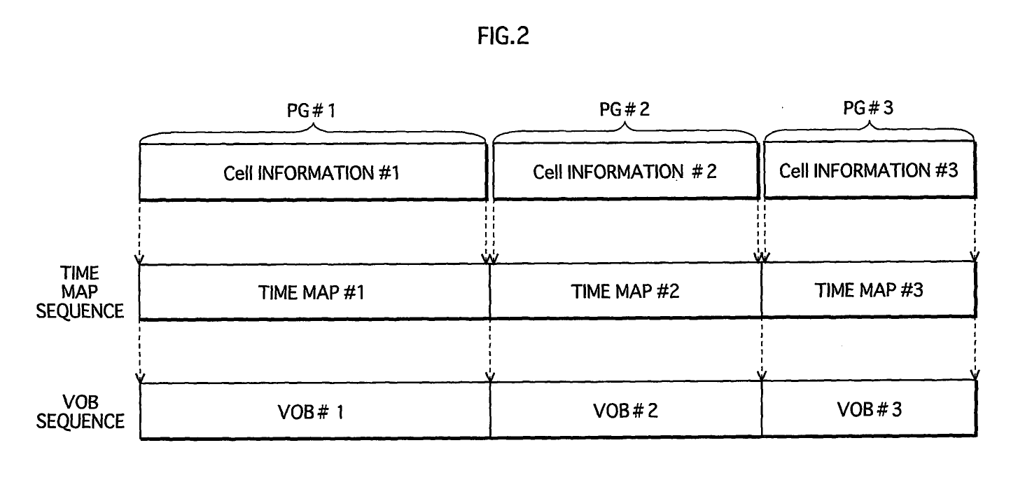

FIG. 2 shows PGs each being comprised of a VOB and management information for the VOB. This diagram describes a VOB sequence comprised of three VOBs, VOB#1, VOB#2, and VOB#3, and in addition, describes three time maps #1, #2, and #3, and three pieces of cell information #1, #2, and #3. In this diagram, the set of “VOB#1-time map#1-cell information #1” constitutes the first PG (PG#1). Likewise, “VOB#2-time map#2-cell information #2” constitutes the second PG (PG#2); and “VOB#3-time map#3-cell information #3” constitutes the third PG (PG#3). In other words, a set of “VOB-time map-cell information” constitutes one PG.

In the described DVD, “playlist (PL) editing” is defined as follows. That is, after receiving from a user a position-deciding operation for deciding In-point/Out-point, the recording apparatus generates a new piece of cell information (1), and generates data called PL information, after reception of an operation for assigning playback order to each piece of cell information (2). The PL information is substantial information that defines a playlist.

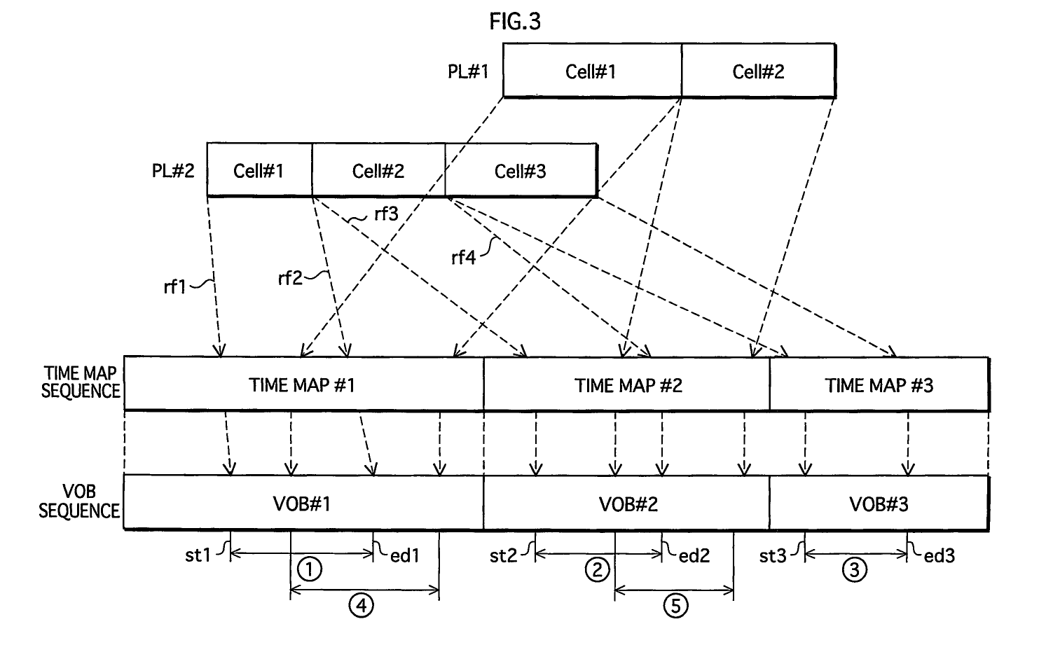

The following describes one example of PL information obtained by the playlist editing. FIG. 3 is a diagram showing one example of PL information created by the playlist editing. The playback path defined by the PL information #2 orders to playback a part (1) of VOB#1, a part (2) of VOB#2, and a part (3) of VOB#3, in the order of (1), (2), and (3). The playback path defined by the playlist #1 orders to playback a part (4) of VOB#1, and a part (5) of VOB#2, in the order of (4) and (5). The PL information#1 includes the cell information #1, #2, and the PL information #2 includes the cell information #1, #2, and #3, respectively. These pieces of cell information specify starting/ending points from the part (1) to the part (5), by indirect reference via the time maps. Since specified by cell information, the parts (1)-(5) will be treated as cells.

In this drawing, the arrow signs rf1, rf2, rf3, rf4, rf5, and rf6 symbolically show this indirect reference. As understandable from the arrow signs rf1, and rf2, the starting points st1, st2, and st3, and the ending points ed1, ed2, and ed3, for the parts (1)-(5) of VOBs #1, #2, and #3, are specified by indirect reference via the respective time maps.

In the PL editing, a remaining part (referred to as “non-referenced part”) is sometimes generated in the VOB sequence. The non-referenced part is a part not referenced by any cell information constituting any PLs, and has much possibility of being deleted. The recording apparatus, after performing the PL editing, extracts non-referenced parts, to display the extracted non-referenced parts to the user, thereby prompting the deletion of the displayed parts. After that, in accordance with the user operation, the recording apparatus performs the deletion. The editing process in which non-referenced parts are deleted is called “substantial editing”.

Please note that the deletion of a non-referenced part mentioned above is to release an area of a DVD to a free area, the area of a DVD corresponding to where the non-referenced area of the VOB sequence is stored. Such release into a free area is performed by updating of the file entry in the file system of the DVD. As follows, the release into free area is described in detail. In a DVD, a VOB sequence is recorded in the state stored in a file. Just as for normal files, the file entry of the file system manages where in the DVD each VOB of the VOB sequence is recorded and how long the VOB is. By being managed by this file entry, the VOB sequence can be fragmented just as the normal files. Since the addresses of the VOBs are managed by the file entry, if the file entry is updated to indicate that among the occupied area by the VOB sequence, the part of the area corresponding to the non-referenced part should be skipped, then the part of the DVD will be released to a free area. This is what the deletion of non-referenced part means.

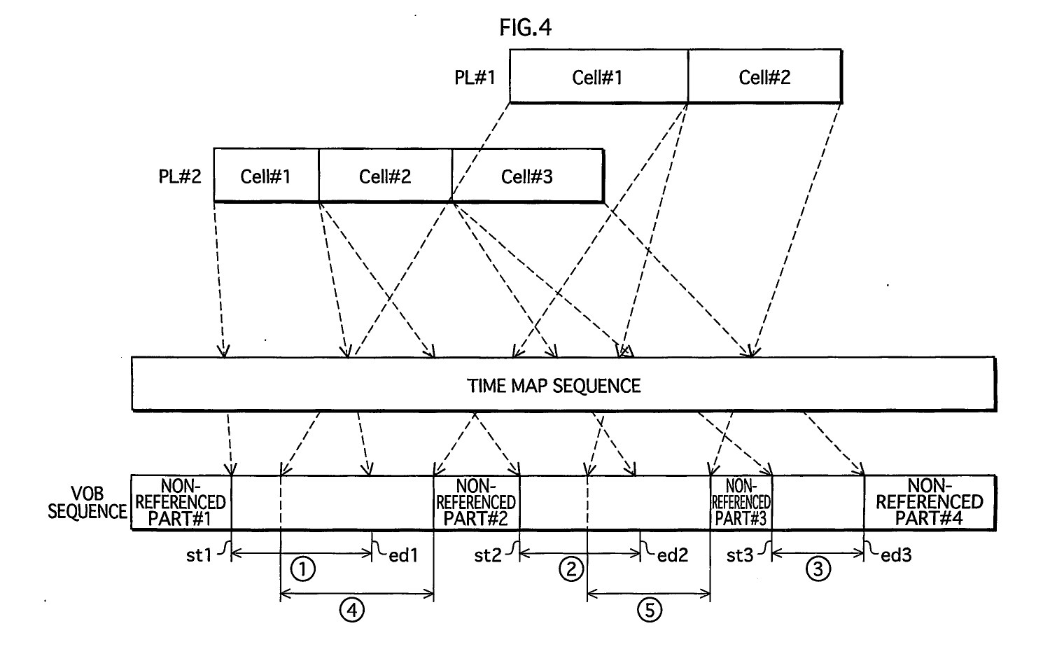

When the example of PL information described in FIG. 3 is generated, which part of the VOB sequence can be non-referenced part is shown in FIG. 4. As shown in FIG. 4, in the example of FIG. 3, from the front-end of the VOB sequence to immediately before the part (1) is the first non-referenced part (non-referenced part #1), from immediately after the part (4) to immediately before the part (2) is the second non-referenced part (non-referenced part #2), from immediately after the part (5) to immediately before the part (3) is the third non-referenced part (non-referenced part #3), and from immediately after the part (3) to the rear-end of the VOB sequence is the fourth non-referenced part (non-referenced part #4). The recording apparatus relating to the present invention performs deletion of such non-referenced parts.

Next, among the embodiments of the recording apparatus of the present invention, the embodiment relating to usage of the recording apparatus is described. The recording apparatus relating to the present invention, together with a television and a remote controller, makes up a home theater system, and is provided for use of the user together with such television and remote controller. The usage by the user means that the user performs a PL editing and a substantial editing, in collaboration with a television 101 and a remote controller 102.

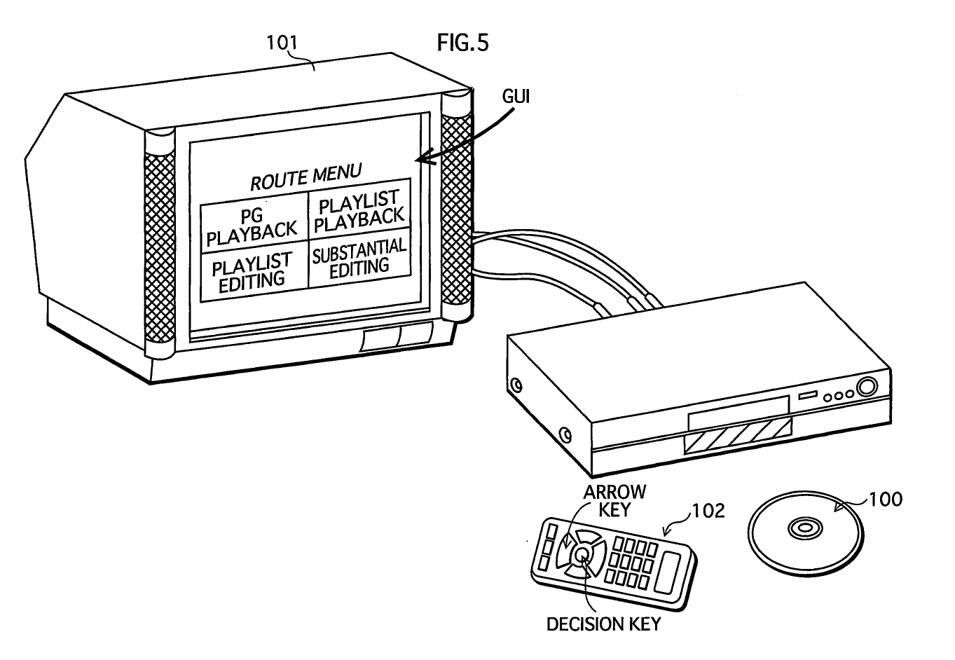

FIG. 5 is a diagram showing the outer appearance of the recording apparatus and a DVD, relating to the present invention. As shown in this drawing, the recording apparatus is connected to the television 101, and is operated through the remote controller 102, for playing back the DVD 100.

The television 101 displays a GUI (graphical user interface) made up of hierarchical menus, and playback images for PL and PG.

The remote controller 102 is an apparatus that receives from a user an operation directed to the hierarchical GUI. For receiving such an operation, the remote controller 102 is equipped with a menu key for invoking menus constituting the GUI, an arrow key for changing the state of the GUI parts constituting a menu, a deciding key for performing the deciding operation in relation to the GUI parts constituting a menu, and a return key for returning to the higher order menu in the hierarchy.

The GUI displayed in this television 101 is described. In the television 101, the GUI is drawn by the OSD (On Screen Display) data. The OSD data is simplified graphics drawn with use of 2, 4 colors shown in Look Up Table (LUT) as background color, and character color. Whereas the VOB and management information constituting a PG are prestored in the DVD, this OSD is generated by the recording apparatus in case of necessity, and is freely updated in accordance with a user operation. The recording apparatus draws the GUI necessary for playlist editing and substantial editing, with use of the OSD, and realizes interactive operation by freely updating the OSD.

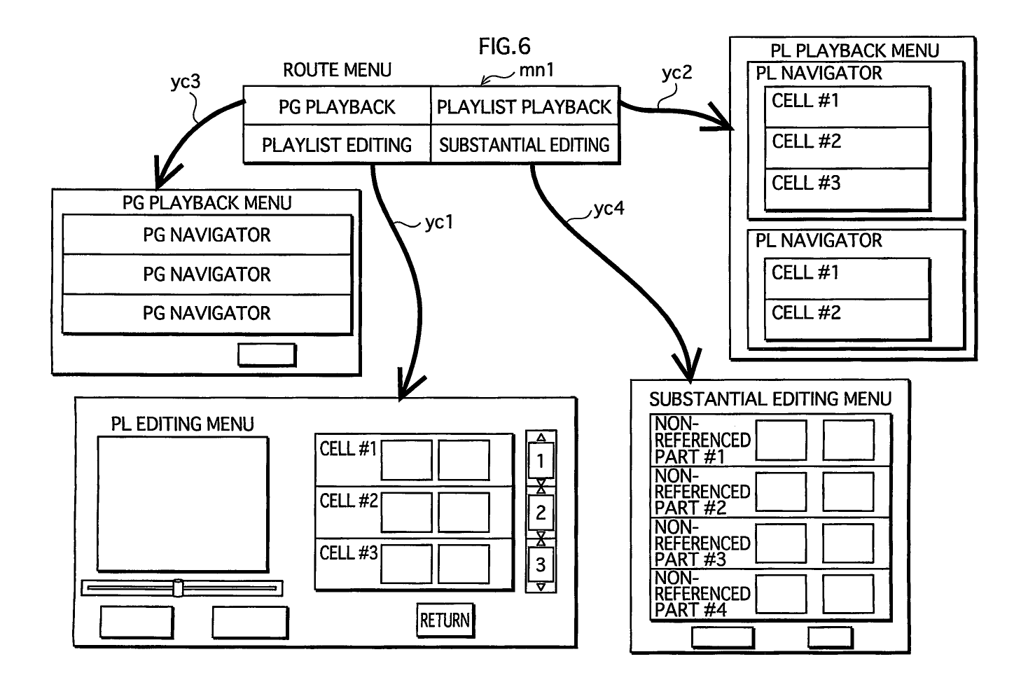

The GUI used in interactive operation performed by the recording apparatus is shown in FIG. 6-FIG. 10. The GUI used in interactive operation is made up of hierarchical menus as shown in FIG. 6. In FIG. 6, the route menu mn1 is situated at the highest order in this hierarchical structure. When the user pushes the menu key in the remote controller, the route menu mn1 will be displayed. This route menu is for receiving a user selection among the items “PG playback”, “playlist playback”, “playlist editing”, “substantial editing”, and so on.

Furthermore, under this route menu, lower order menus such as “PG playback menu”, “PL playback menu”, “PL editing menu”, and “substantial editing menu”, and so on.

The arrow signs in the drawing schematically show the switching from one menu to another. If the “playlist editing” in the route menu is selected, switching is performed from the route menu to the PL editing menu, as shown by the arrow sign yc1. If the item “PL playback” in the route menu is selected, switching is performed from the route menu to the PL playback menu, as shown by the arrow sign yc2. If the item “PG playback” in the route menu is selected, switching is performed from the route menu to the PG playback menu, as shown by the arrow sign yc3, and if the item “substantial editing” in the route menu is selected, switching is performed from the route menu to the substantial editing menu.

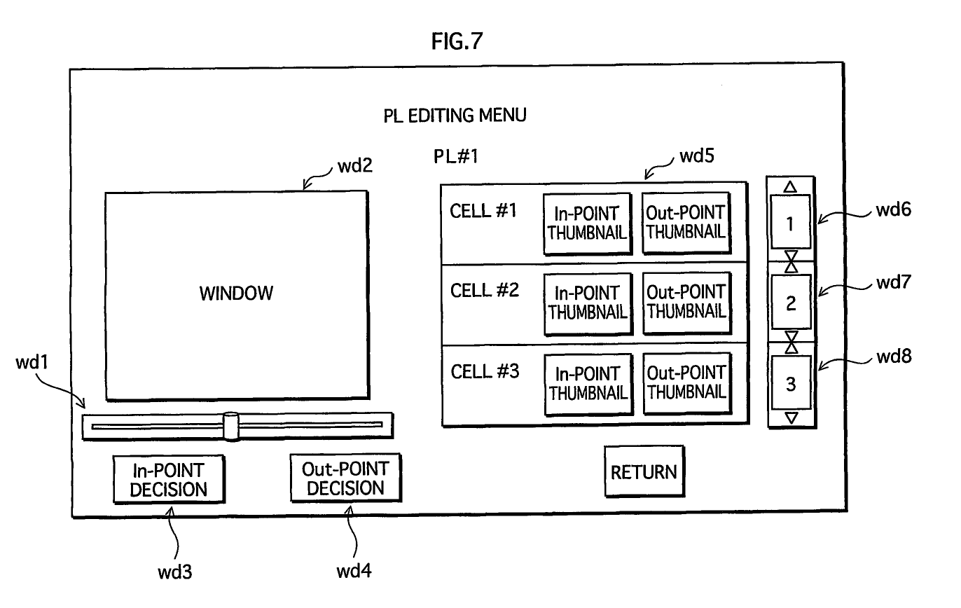

As follows, the menu used in playlist editing is described. FIG. 7 shows an example of the menu used in playlist editing.

The playlist editing menu is made up of such GUI parts as a slide bar wd1, a window wd2, an In-point/Out-point buttons wd3 and wd4, a cell navigator wd5, and numerical value fields wd6, wd7, and wd8.

The slide bar wd1 is a GUI part for receiving from a user a position-deciding operation to decide the In-point/Out-point for a cell. By pushing the left/right key of the remote controller 102, the slide bar can be moved on the guide in left and right directions, and the position-deciding operation is performed by converting the position of the slide bar on the guide, into the position on the VOB. For example if the object of playlist editing is two-hour VOB, and the slide bar positions substantially in the middle of the guide, then the position after one hour from the front-end of the VOB will be specified.

The window wd2 is a GUI part for giving user a feedback on which part of the VOB has been specified by the position-deciding operation for the slide bar. According to the position-deciding operation in relation to the slide bar, and the feedback by means of the window wd2, fine adjusting of the positions to be In-point/Out-point is realized.

The In-point/Out-point buttons wd3 and wd4 are GUI parts for finally deciding the positions of the slide bar in the guide, as In-point/Out-point. Once the In-point and the Out-point for a cell are decided, by pushing of the In-point/Out-point buttons, this results in generation of the cell.

The cell navigator wd5 graphically represents the cell generated by the position deciding by means of the slide bar and of the deciding operation in relation to the In-point/Out-point. Specifically, the cell is represented by a thumbnail for the picture data positioning at the In-point of the cell (playback section), and a thumbnail for the picture data positioning at the Out-point of the cell. If the two or more cells are already generated, then the cell navigators will appear in the screen, in the same number as for the generated cells (three cell navigators in FIG. 7 imply that the three cells are already generated). The PL is comprised of cells represented by these cell navigators.

The numerical value fields wd6, wd7, and wd8 are for receiving order-assigning operation for each cell navigators. This order-assigning operation is performed by input in the numerical value field a numerical value from among 1−n. “n” represents a total number of cells, represented by the cell navigators. The numerical value inputted in this numerical value field is interpreted as a playback order of the corresponding cell.

Generating process of a PL is as follows: the cells are defined by the position-deciding operation by means of the slide bar and by the deciding operation in relation to the In-point/Out-point buttons; then, the playback order of each cell is defined by means of input of a numerical value in the numerical value field of each cell navigator.

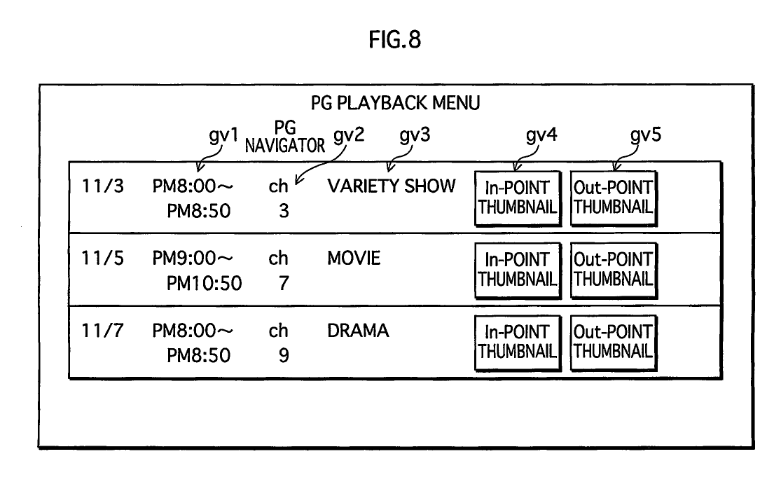

Next, the menu that the recording apparatus uses in PG playback is described, with reference to FIG. 8. FIG. 8 is a diagram showing the menu that the recording apparatus uses in PG playback. In the menu of FIG. 8, three PG navigators are disposed. A PG navigator is a GUI part that graphically describes a PG. In the PG navigator, the following are disposed: recording date/time “gv1” of the PG (made up of the date of recording and the time of recording); a broadcast channel “gv2” through which the PG was broadcasted; the title of the PG“gv3”; and thumbnails “gv4” and “gv5”, respectively for the front-end/rear-end images of the PG. The PG navigator has three states: normal state; focus state; and active state. The normal state is a state of not being selected by a user; the focus state is a state of being selected as a playback alternative by means of the arrow key of the remote controller; and the active state is a state of being decided as the program to be played back. By changing the state of each PG navigator, it is possible to easily perform selection as to “which PG has to be played back”.

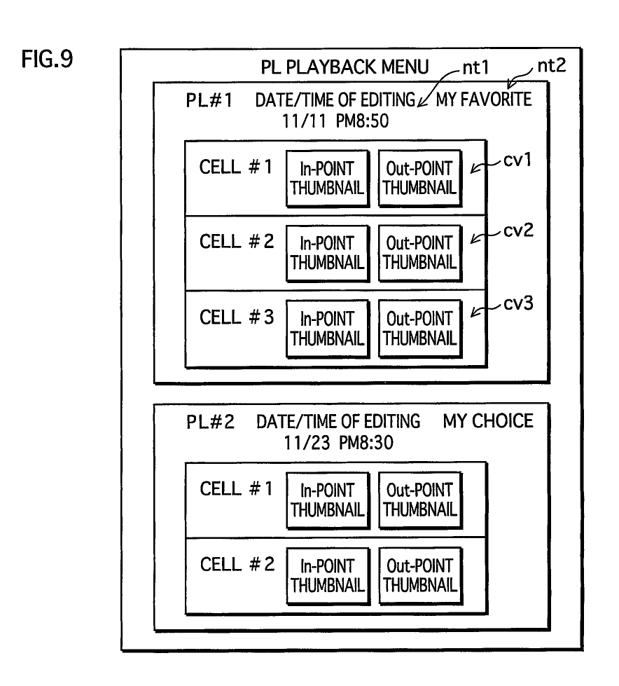

Following this, the menu to be used in PL playback is described with reference to FIG. 9. FIG. 9 is a diagram showing the menu that the recording apparatus uses in PL playback. The menu in FIG. 9 has two PL navigators. In each PL navigator, cell navigators “cv1”, “cv2”, “cv3”, that constitute the PL are disposed in accordance with the cells' playback order. Also included in each PL navigator are the date/time of editing “nt1” and the title “nt2”.

The PL navigator, just as the PG navigator, has three states: normal state; focus state; and active state. The normal state is a state of not being selected by a user; the focus state is a state of being selected as a playback alternative by means of the arrow key of the remote controller; and the active state is a state of being decided as the program to be played back. The recording apparatus plays back the PL that corresponds to the PL navigator that has been set to the active state in this PL playback menu.

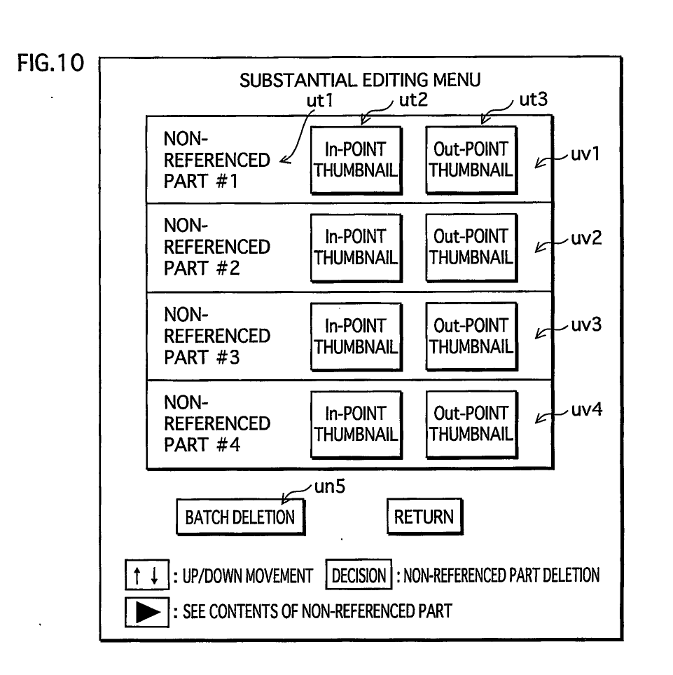

Next, the substantial editing menu is described with reference to FIG. 10. FIG. 10 is a diagram showing one example of the substantial editing menu. The substantial editing menu includes therein: a plurality of non-referenced part navigators “uv1”, “uv2”, and “uv3”, and a batch deletion button “un5”. Each non-referenced part navigator is a GUI part for graphically representing a non-referenced part. An identifier relating to the non-referenced part, and two thumbnails “ut2” and “ut3” represent each non-referenced part navigator. The two thumbnails, in a non-referenced part navigator, each are reduced images obtained by scaling down pieces of picture data each belonging to the front-end/rear-end of the non-referenced part. By looking at the thumbnails included in each non-referenced part navigator, the user can surmise whether the non-referenced part contains a valuable image worthy of preservation or not.

The non-referenced part navigator has three states: normal state; focus state; and active state. The normal state is a state of not being selected by a user; the focus state is a state of being selected as a deletion alternative by means of the arrow key of the remote controller; and the active state is a state of being decided as the part to be deleted. The recording apparatus displays non-referenced part navigators in response to the user's choosing of a substantial editing. Therefore, at the time when a user shows intention of performing substantial editing, the user can know how many parts can be deleted.

The batch deletion button un5 is a GUI part to be assigned to such as a picture-recording key of the remote controller, and receives an operation that all the non-referenced parts displayed in the menu should be deleted collectively.

The usage of the recording apparatus relating to the present invention is to make the recording apparatus perform playlist editing, substantial editing, and playback operations, with use of the aforementioned GUI.

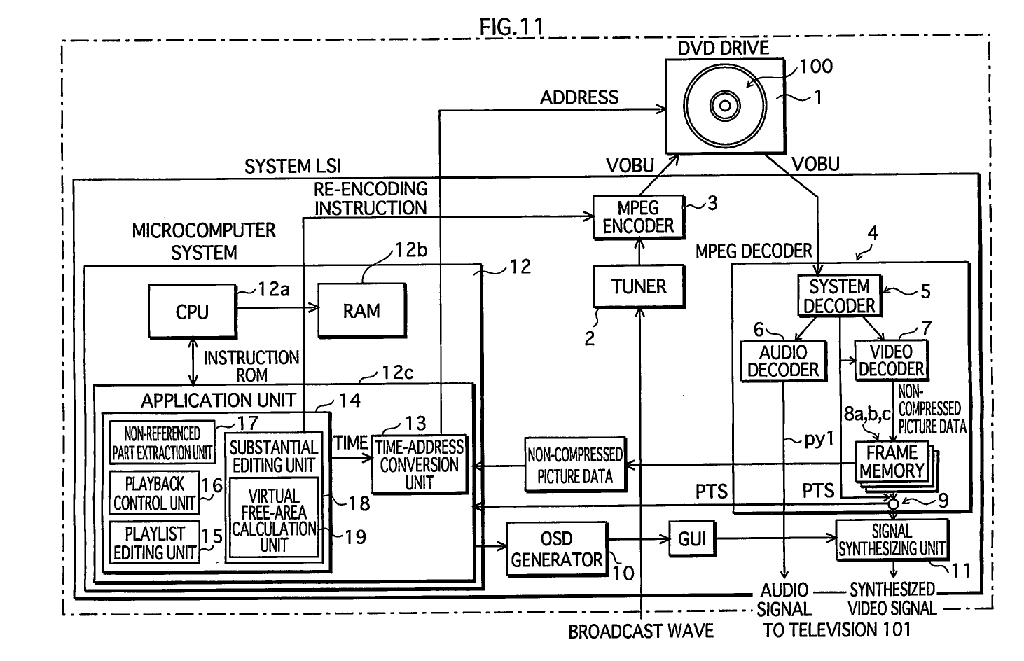

Next, among the various embodiments that the recording apparatus of the present invention has, the embodiment relating to the production of the recording apparatus is described. The recording apparatus relating to the present invention is mainly made up of two parts: a system LSI, and a drive device, and is industrially manufacturable by mounting these parts to the cabinet or to the board, of an apparatus. The system LSI is a circuit into which varieties of process units performing functions of the recording apparatus are integrated. FIG. 11 is a diagram showing the internal structure of the recording apparatus. As shown in this drawing, the recording apparatus is made up of a DVD drive 1 and a system LSI. The system LSI is comprised of hardware resources such as: a DVD drive 1, a tuner 2, an MPEG encoder 3, an MPEG decoder 4 (including a system decoder 5, an audio decoder 6, and a video decoder 7), frame memories 8a, b, c, an order controlling unit 9, an OSD generator 10, a signal synthesizing unit 11, and a micro computer system 12. These constituting elements are described as follows.

The DVD drive 1 is an apparatus to which the DVD 100 is loaded. The DVD drive 1 reads an arbitrary VOBU from the DVD, and deletes an arbitrary VOBU from a DVD. The reading/deletion of VOBUs are performed according to read commands and delete commands that the system LSI issues.

The tuner 2 demodulates a broadcast signal for television, thereby outputting an image signal and an audio signal to the MPEG encoder 3.

The MPEG encoder 3 obtains a VOBU by encoding image/audio signals that have been demodulated by the tuner 2. In addition, the MPEG encoder 3 performs re-encoding, where the already encoded two VOBUs are encoded again to synthesize them to one VOBU.

The MPEG decoder 4 is a dedicated circuit for decoding the VOBU read by the DVD drive 1, and is equipped with the system decoder 5, the audio decoder 6, and the video decoder 7.

The system decoder 5 obtains a GOP and a plurality of audio frames, by making the video decoder 7 perform multiplex separation on a VOBU.

The audio decoder 6 decodes the plurality of audio frames, thereby obtaining an audio signal.

The video decoder 7 performs, on a bidirectionally predictive (B) picture, predictive (P) picture, and an intra (I) picture, such processes as VLD (variable-length code decoding), IQ (inverse quantization), IDCT (inverse DCT conversion), and MC (motion compensation), thereby storing picture data in a digital non-compressed state in the frame memories 8a, b, and c.

The frame memories 8a, b, and c are respectively assigned to the three types of picture data (i.e. I picture, B picture, and P picture). Accordingly, each frame memory 8a, b, and c separately stores picture data in non-compressed state, which have been obtained by decompressing the three types of picture data.

The order controlling unit 9 sequentially reads pieces of picture data, in the non-compressed state, stored in the frame memories 8a, b, and c, at a timing shown by the PTS (presentation time stamp) assigned to the respective pieces of picture data. On the other hand, the order-controlling unit 9 sequentially outputs the PTSs themselves assigned to the respective pieces of picture data, to the microcomputer system 12. While being stored in the DVD 100, the plurality of pieces of picture data constituting a VOBU are aligned in an order called “encoding order”. In playback of the VOBU, the pieces of picture data must be realigned in the display order. The order controlling unit 9, so as to perform such realigning, reads, according to the order shown in the PTSs, the I picture, P picture, and B picture, that have been respectively stored in the frame memories 8a, b, and c.

Since PTSs assigned to the corresponding piece of picture data are outputted to the microcomputer system 12, the microcomputer system 12 can know playback time to which each piece of the picture data stored in the frame memories 8a, b, and c, corresponds. Therefore, pieces of picture data are freely used, such as reading pieces of picture data from the frame memories 8a, b, and c, and after reducing, disposing them on the PL editing menu.

The OSD generator 10 generates the OSD representing the menu shown in FIG. 6-FIG. 10, and outputs the OSD to the signal-synthesizing unit 11, so that the OSD will be synthesized with picture data. Then the OSD is updated according to a user operation performed on the remote controller. Updating of the OSD includes changing a PL navigator and a PG navigator to a focus state from a normal state, and moving the slide bar on the guide in left and right directions. Thanks to the OSD updating performed by the OSD generator 10, operations are realized such as a position-deciding operation for deciding the In-point/Out-point of a cell, and an order-assigning operation for assigning the playback order to each cell.

The signal-synthesizing unit 11 synthesizes the OSD with picture data, by mixing the horizontal lines constituting the non-compressed picture data and the horizontal lines of the OSD, thereby converting the picture data into an image signal for television. According to the mixing ratio set in this mixing operation, the signal-synthesizing unit 11 can make the picture data covered by the OSD, or make the picture data be see-through.

The microcomputer system 12 is equipped with a CPU 12a, a RAM 12b, and an instruction ROM 12c, and performs integration/control by making the CPU 12a execute the program stored in the instruction ROM 12c. The instruction ROM 12c prestores a basic program for realizing the conversion function between time-and-address, and an application program. These programs function as a time-address conversion unit 13 and as an application unit 14, by being read by the CPU 12a.

So far is the description on the hardware structure of the recording apparatus. Next, the software structure of the recording apparatus is described. The software structure of the recording apparatus is comprised of the time-address conversion unit 13 and the application unit 14.

As follows, this software structure is described.

The time-address conversion unit 13 receives, from the application unit 14, specification of a VOB-ID, and relative time for the In-point/Out-point. These ID and relative time are then converted to the start address of a VOBU. This conversion operation is performed with reference to the time map. More specifically, in the VOB identified by the VOB-ID received by the application unit 14, calculation is performed as to the position of the VOBUs that respectively include the In-point/Out point, from the beginning of the VOB in byte, with reference to the time map. By this operation the start address of the VOBU is calculated. Then, directed to this start address, a read command and a delete command are issued in the DVD drive 1. By involving the time-address conversion unit 13, the application unit 14 does not have to think about the address of each VOBU in the DVD, in performing PL editing, substantial editing, and PG/PL playbacks.

The application unit 14 is the actual means realized by collaboration between the application program and the hardware of the microcomputer system 12, and is equipped with a playlist editing unit 15, a playback control unit 16, a non-referenced part extraction unit 17, a substantial editing unit 18, and a virtual free-area calculation unit 19.

The PL editing unit 15 generates a PL, based on a position-deciding operation of deciding the In-point/Out-point of cells, and an order-assigning operation of assigning playback order to each cell, that are performed in response to the display of playlist editing menu. More specifically, the playlist editing unit 15 acquires the VOB-ID of the VOB that the In-point belongs to, as well as acquiring the relative time from the front-end of the VOB to the In-point (Cell_StarT_PTM). By this operation, the In-point of the cell is decided. Likewise, the relative time from the front-end of the VOB to the Out-point (Cell_End_PTM) is acquired. Once the VOB-ID, Cell_StarT_PTM, and Cell_End_PTM, that identify the In-point/Out-point, are obtained, this means the generation of cell information. After generation of cell information is performed more than twice, and an order-assigning operation is performed with respect to the cell navigators, the cells are assigned playback order, and are disposed in the memory according to the playback order. By this operation, a PL is obtained.

The playback control unit 16 displays on the television 101 such as a PG navigator representing the PG prestored in the DVD, and a PL newly generated by the playlist editing unit 15. Then the playback control unit 16 controls the DVD drive 1 and the MPEG decoder 4, so as to playback either the PL or the PG, in accordance with the user instruction in relation to the PG navigator and the PL navigator. This playback control is performed via the following processes. That is, once the PL is selected, the playback control unit 16 makes the time-address conversion unit 13 search for the start addresses respectively for the VOBU including the In-point and the VOBU including the Out-point, based on the VOB-ID and the relative time of the cell information constituting the PL information. Then, the playback control unit 16 instructs the DVD drive 1 to read from the VOBU including the In-point to the VOBU including the Out-point. Then, the playback control unit 16 instructs the MPEG decoder 4 to playback/output the picture data from the In-point to the Out-point, among the VOBUs read out in the above way. The same operation as above is repeated to all the cells constituting the PL, thereby realizing the playback operation based on the PL.

The non-referenced part extraction unit 17 extracts parts of the VOB that are not referenced by any of the cells constituting the respective PLs. Specifically, the parts that the non-referenced part extraction unit 17 extracts are one of (i) from the front-end of the VOB sequence to immediately before the In-point of any cell, (ii) from immediately after any cell to the rear-end of the VOB sequence, and (iii) from immediately after the Out-point of any cell to immediately before the In-point of the next cell. The non-referenced part extraction unit 17 represents the In-point/Out-point of these non-referenced parts, by VOB-ID and relative time from the front-end of the VOB. The reason why the In-point/Out-point are represented by the VOB-ID and the relative time from the front-end of the VOB is to maintain the compatibility between the notation systems for the cells. By these operations, list information (non-referenced part list) is obtained in which In-point/Out-point for non-referenced parts are listed.

The substantial editing unit 18, when instructed to delete any of the non-referenced parts in the substantial editing menu of FIG. 10, makes the time-address conversion unit 13 calculate the address of the VOBU including the In-point, and the address of the VOBU including the Out-point. Then, the substantial editing unit 18 instructs the DVD drive 1, via the time-address conversion unit 13, to delete from the VOBU including the In-point to the VOBU including the Out-point. Such deletion enlarges the free area of the DVD. Prior to the deletion of non-referenced parts, the substantial editing unit 18 makes the DVD drive 1 read the VOBU including the In-point and the VOBU including the Out-point, and provides instructions so that re-encoding of the In-point including VOBU and the Out-point including VOBU should be performed, so that these VOBUs will be played back seamlessly. In the re-encoding, the VOBUs that position after the In-point-including VOBU and the VOBUs that position before the Out-point-including VOBU have possibility of being a target of re-encoding. The reason why the VOBUs positioning after the In-point-including VOBU could be target of re-encoding is that it is probable that any of these VOBUs include audio frames to be played back in synchronization with the In-point picture data.

In addition, the reason why the VOBUs positioning before the Out-point-including VOBU could be target of re-encoding is that if these VOBUs include an Open-GOP, and the In-point picture data is one of B picture and P picture, it is likely that this B or P picture which corresponds to the In-point refers to the picture data among the VOBUs prior to the In-point-including VOBU.

The virtual free-area calculation unit 19, when any of the non-referenced parts is selected for deletion, displays to the user a virtual free-area size. Please note that incident to the deletion of non-referenced part, the amount of data used for re-encoding the In-point-including VOBU and the Out-point-including VOBU will be additionally stored in a recording medium. Therefore, in calculation of a virtual free-area, the size resulting after subtracting this additional amount from the data size of the non-referenced part to be deleted is displayed as the virtual free-area increase.
i.e. the value obtained by the expression (data size of non-referenced part)−(size of VOBU obtained by re-encoding) will be displayed as a virtual free-area increase.

So as to calculate the increase incurred by the re-encoding, the virtual free-area calculation unit 19, makes the MPEG encoder 3 perform re-encoding. Then using thus calculated data size, the virtual free-area calculation unit 19 displays the virtual free-area calculated in the above way, to the user. The reason why this value is displayed as a virtual free-area size is that if the non-referenced part is very small in size, the value obtained by the above expression will be smaller than the user expects, which disappoints the user.

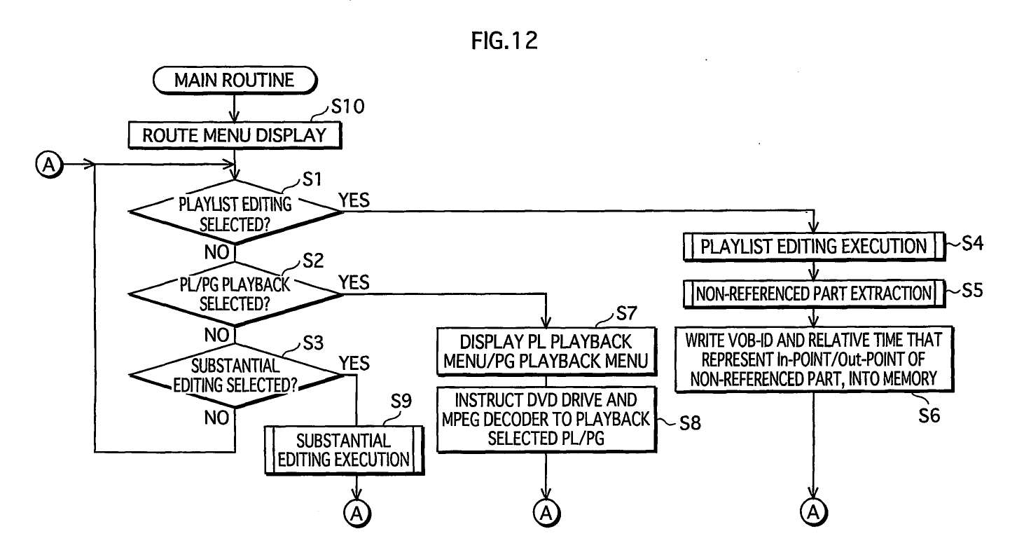

The application unit 14 made up of from the playlist editing unit 15 to the virtual free-area calculation unit 19 is produced by creating a computer-readable program in which the processes shown in the flowcharts of FIGS. 12, 13, 14, 21, and 22 are written in a computer language (e.g. c-language, machine-language, and Java-language). The processes necessary to be written for production of the application unit 14 are described with reference to the flowcharts of FIGS. 12, 13, 14, 21, and 22. FIG. 12 is a flowchart showing the process performed in the main routine of the remote controller. In FIG. 12, after the route menu is displayed in Step S10, the control is moved to the loop process comprised of Steps S1-S3.

Steps S1-S3 performed by the application unit 14 constitute a selection-waiting loop. The process that this loop waits for is such as PL editing, playback process, and substantial editing. If PL editing is selected (Step S1: Yes), the playlist editing unit 15 performs PL editing at Step S4, and obtains a PL. Following this, at Step S5, the non-referenced part extraction unit 17 extracts as non-referenced part, the part not referenced by any of the cells of the PL in the VOB sequence, and at Step S6, a relative time and an VOB-ID that shows the In-point/Out-point for the non-referenced part are written into the memory, thereby obtaining a non-referenced part list.

If PG/PL playback processes are selected, the playback control unit 16, at Step S7, displays the PG playback menu and the PL playback menu, for the user to select either a PL or a PG. Then, the playback control unit 16, at Step S8, instructs the DVD drive 1 and the MPEG decoder 4 to play back the PL/PG selected at Step S8. If substantial editing is selected, the substantial editing unit 18, at Step S9, deletes the non-referenced part shown in the non-referenced part list, thereby obtaining a free area.

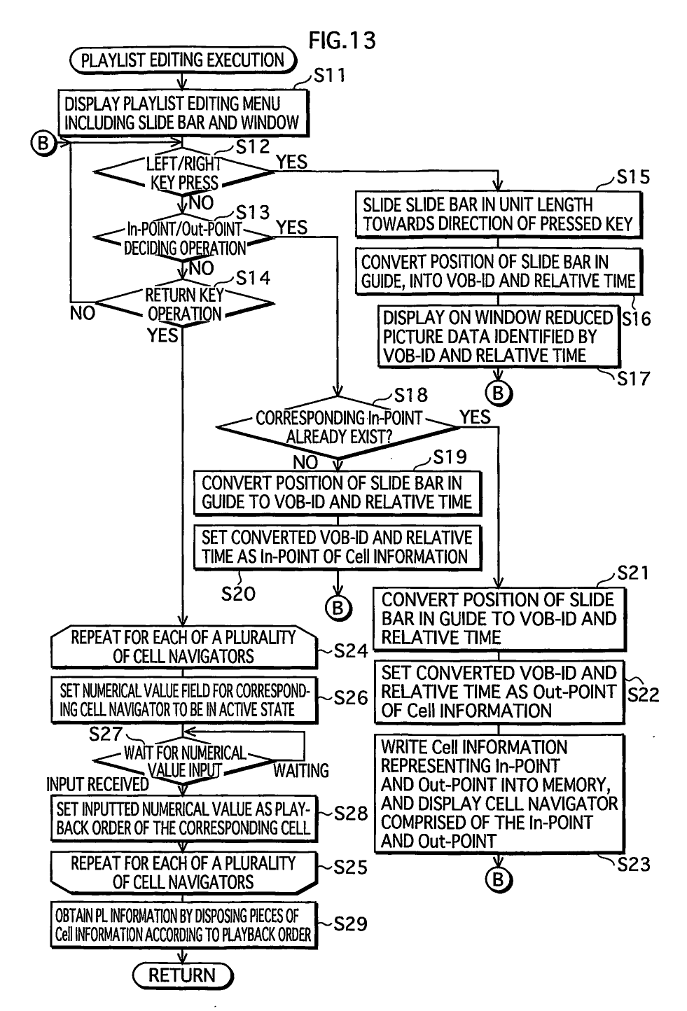

Next, with reference to FIG. 13, the process performed by the playlist editing is described. FIG. 13 is a flowchart showing the process performed by the playlist editing unit 15.

In the flowchart of FIG. 13, at Step S11, the playlist editing menu including such as a slide bar and a window is displayed. Then, according to instruction given by one of left/right key presses (Step S12), an In-point/Out-point deciding button press (Step S13), and a return key press (Step S14), the processes of Steps S15-S17, Steps S18-S23, and Steps S24-S29 are selectively performed.

Specifically, at Steps S15-S17, the slide bar is slid for a unit length in the direction of the pressed key (Step S15) Every time the slide bar is slid in the unit length, the position of the slide bar on the guide is converted into a VOB-ID and a relative time (Step S16). This operation is for reducing and then displaying in the window, the picture data identified by the VOB-ID and the relative time (Step S17).

In the aforementioned Steps S15-S17, as long as the left/right press is continuing, the slide bar will be continually slid. Then, the picture data corresponding to where the slide bar is will be displayed in the window. According to this operation, the user decides the desired position as an alternative for the In-point/Outpoint.

Steps S18-S23 are for deciding the position of the slide bar as In-point/Out-point, at the time when the In-point/Out-point deciding button is pressed. Prior to this decision, judgment is performed as to whether the In-point already exists (Step S18), and if judgment results in the negative, the position of the slide bar is converted into a VOB-ID and a relative time (Step S19), and the VOB-ID and the relative time obtained by the conversion are set in the cell information as In-point (Step S20).

If the corresponding In-point has been already set, the position of the slide bar in the guide is converted into a VOB-ID and a relative time (Step S21), and the VOB-ID and the relative time are set in the cell information as Out-point (Step S22). Then, the cell information showing the In-point/Outpoint is written to the memory. Then, a cell navigator made up of the In-point/Out-point is displayed (Step S23).

By repeating a series of processes in which the slide bar is moved and the In-point/Out-point deciding button is pressed, pieces of cell information are sequentially generated, and a plurality of cell navigators appear on the menu.

Steps S24-S29 are for generating a plurality of cell navigators, which are performed when the return key is pressed. In Steps S24-S29, the numerical value fields for the corresponding cell navigators are set to be in an active state (step S26), and a numeric value input is waited (Step S27). If a numeric value is inputted, the inputted numeric value is set as a playback order in the corresponding cell (Step S28). The processes mentioned so far are repeated for a plurality of cell navigators (Step S24, S25). When the playback order for all the cells is set, the pieces of cell information are disposed according to this playback order, thereby obtaining PL information (Step S29). This is the end of description about the playlist editing.

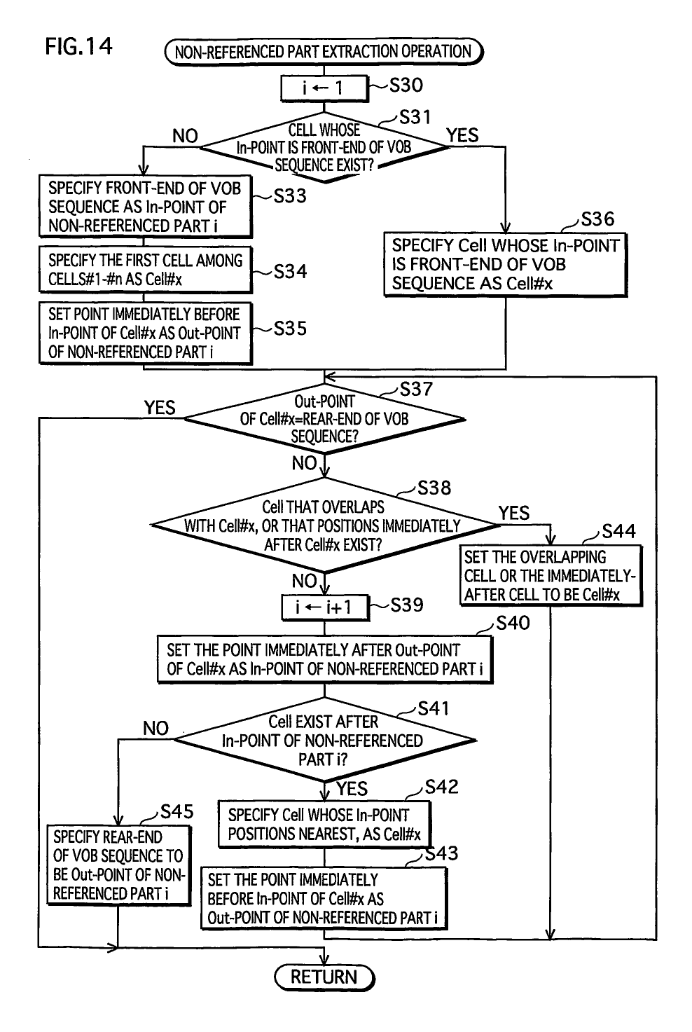

As follows, the processes for extracting non-referenced part are described with reference to the flowchart of FIG. 14. FIG. 14 is a flowchart showing the processes performed by the substantial editing unit 18. In this flowchart, the variable “i” is for identifying non-referenced part that is extractable, and “#x” is among the cells belonging to the PL, and works as a variable for representing a delimiter of non-referenced part.

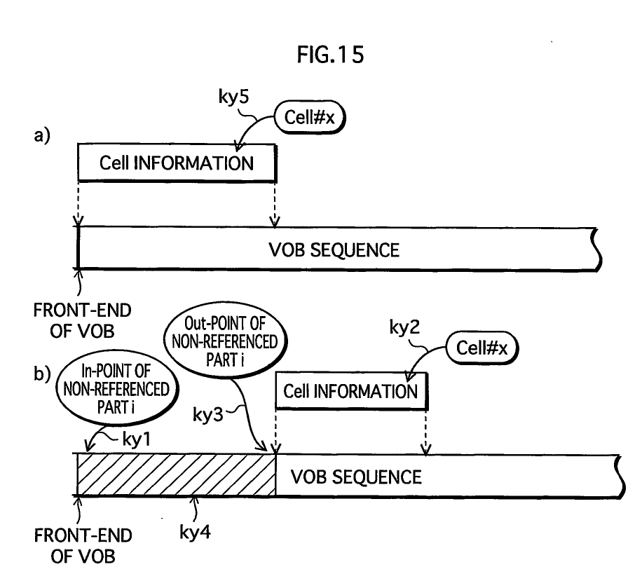

After the variable “i” is reset to an initial value 1, judgment as to whether the beginning part of the VOB sequence should be non-referenced part is performed at Step S31. This step specifically is for judging whether the case is FIG. 15A or FIG. 15B. FIG. 15A is a case where the beginning part of the VOB sequence is specified as a cell of a PL. FIG. 15B is a case where the beginning part of the VOB sequence is not specified as a cell of any PL. In the case of FIG. 15B, the beginning part of the VOB sequence can be a non-referenced part.

If there is no cell that has the front-end of the VOB sequence specified as In-point, then at Step S33, the beginning part of the VOB sequence is set to be the In-point of the non-referenced part “i”, as shown by the arrow sign ky1 of FIG. 15B. Then, at Step S34, among the cells #1-#n that belong to one PL, the cell that has the In-point appearing first will be specified as Cell#x, as shown by the arrow sign ky2. At Step S35, the part before the Cell#x is delimited as a non-referenced part.

The delimiting is performed so that the point immediately before the In-point of the Cell#x is specified as Out-point of the non-referenced part “i”, as shown by the arrow sign ky3 of FIG. 15B (Step S35). By doing this, as shown by the arrow sign ky4, the part shown by hatch pattern is decided as non-referenced part, and the control is moved to Step S37.

If there is no cell, in any PL, that specifies the front-end of the VOB sequence as In-point, it is impossible to specify the beginning part of the VOB sequence to be non-referenced part. Therefore, at Step S36, the cell whose In-point is the front-end of the VOB sequence is specified as Cell#x, as shown by the arrow sign ky5, and the control is moved to Step S37.

Step S37 plays a role of an entrance to the loop operation made up of Steps S37-S43, by being positioned at the intersection between the processes performed at Steps S33-S35 and the process of Step S36.

Specifically this loop operation is an incessant repetition of the processes described as follows. First, the point immediately after the Out-point of the Cell#x is set as In-point of the non-referenced part “i” (Step S40), and the cell positioning after the In-point of the non-referenced part “i” is set as a new Cell#x (Step S41, Step S42), and the point immediately before the In-point of the new Cell#x is set as the Out-point of the non-referenced part “i” (Step S43).

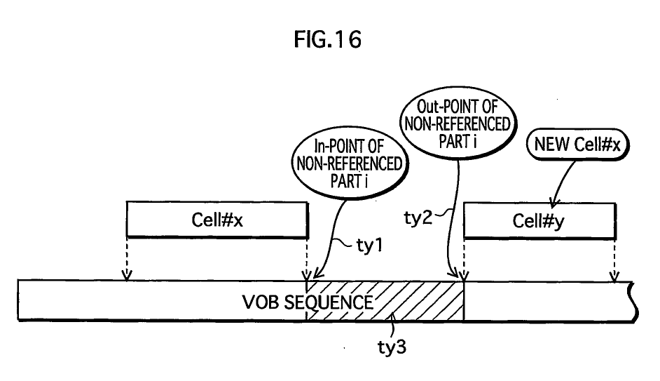

The variable “i” specifying the non-referenced part is incremented at Step S39. That is, the variable “i” is incremented every time this loop operation ends one loop, and the part between the former Cell#x and the new Cell#x to be ith non-referenced part is specified as non-referenced part. FIG. 16 is a diagram showing how non-referenced parts are specified by the repetition of this loop operation.

The Cell#x in this diagram does not have any cell that positions immediately after, nor have any overlapping cell. Therefore, at Step S40, the point immediately after the Out-point is set to be the In-point of the non-referenced part “i”, as shown by the arrow sign ty1. Then, the cell#y that positions after the In-point of the non-referenced part “i” and that is the nearest to this In-point is set to be a new Cell#x, as shown by the arrow sign ty2 (Step S41, Step S42). The point immediately before the In-point of the new Cell#x is set to be the Out-point of the non-referenced part “i” (Step S43). By doing this, the part shown by hatch pattern is decided as a non-referenced part, as shown by the arrow sign ty3. After this, the same operation is repeated for the cells that come after this new Cell#x. These are the contents of the loop operation of Steps S37-S43.

The conditions for ending this loop operation are that: the Out-point of the Cell#x coincides with the rear-end of the VOB sequence (Step S37: Yes); and within any PL, no cell exists whose In-point positions after the In-point of the non-referenced part “i” (Step S41: No). Unless these ending conditions are met, this loop operation will be repeated.

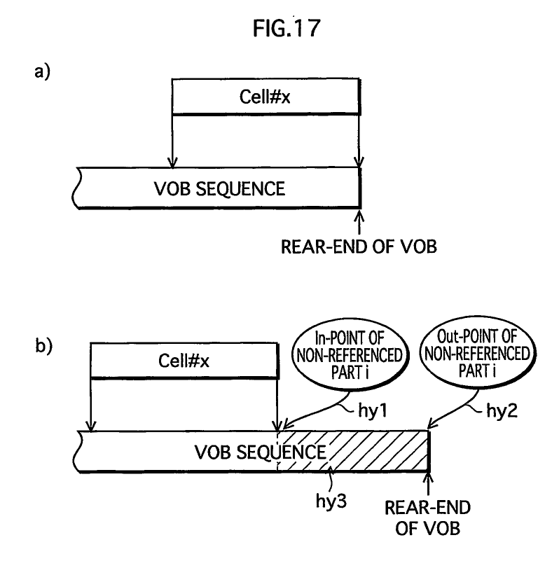

FIGS. 17A and 17B are diagrams showing the two cases that satisfy the ending conditions of the loop operation. FIG. 17A is a case in which the Out-point of the Cell#x coincides with the rear-end of the VOB sequence. In this case, after the operation of this flowchart is ended, the control will return to the main routine. FIG. 17B is a case in which the Out-point of the Cell#x does not coincide with the rear-end of the VOB sequence. In this case, at Step S40 in the loop operation, the point immediately after the Out-point of the Cell#x is set to be the In-point of a non-referenced part, as shown by the arrow sign hy1. Accordingly, as shown by the arrow sign hy2, the rear-end of the VOB sequence is set to be the Out-point of the non-referenced part. As a result of these operations, the non-referenced part is decided as shown by the arrow sign hy3.

The above description is based on the premise that there is no overlapping cell with the Cell#x, and there is no cell that positions immediately after the Cell#x. If such an overlapping cell, or the cell that positions immediately after the Cell#x exists (Step S38: Yes), then Step S38 and Step S44 constitute a loop operation. This loop operation is to be performed prior to executing Steps S39-S43. Unless the control will pass through Steps S38-S44, Steps S39-S43 will not be performed. Steps S38-S44 are for repeating the operations of setting a cell that overlaps with the Cell#x, and a cell that positions immediately after the Cell#x, to be a new Cell#x (Step S44).

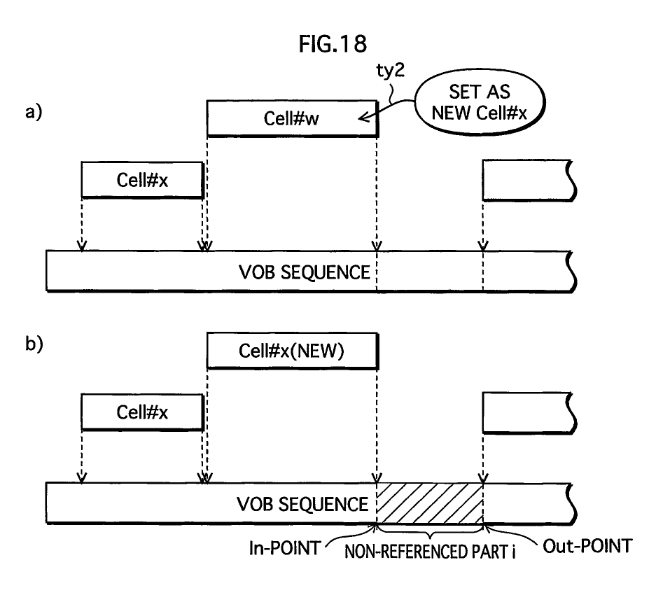

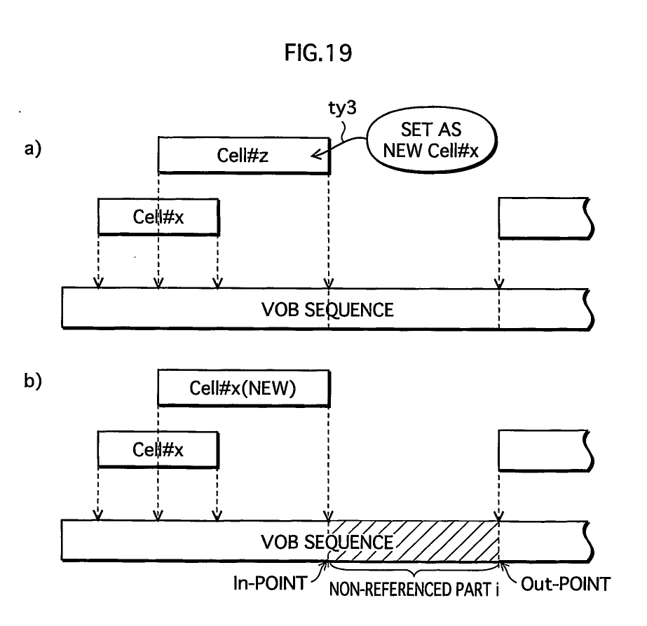

FIGS. 18 and 19 are diagrams showing the cases in which the processes of Steps S38-S44 are repeated. The cell that can be a new cell in Steps S38-S44 is Cell#w or Cell #z, respectively shown in FIGS. 18 and 19. The Cell#w in FIG. 18A has In-point immediately after the Cell#x, and has Out-point after the Out-point of the Cell#x. The Cell#z in FIG. 19 has In-point within the Cell#x and has Out-point after the Out-point of the Cell#x. These Cell#w and Cell#z cannot be delimiters of non-referenced part, even if these cells come after the Cell#x. This Step S44 decides cells that do not work as a delimiter of non-referenced part, and skips these cells. According to this skip, Cell#w and Cell#z of FIGS. 18A and 19A are made to be respective new Cells#x, as shown by the arrow signs ty2 and ty3.

As a result of these skips, free areas respectively following the new Cells#x are set to be non-referenced part.

One condition for ending this loop operation is that: the Cell#x has reached to where there is no overlapping cell with the Cell#x, and to where there is no cell that positions immediately after the Cell#x. Another ending condition is that, from the beginning, there is no overlapping cell with the Cell#x, and that there is no cell that positions immediately after the Cell#x. In this case, Step S38 is No, and the control is moved to Steps S39-S43.

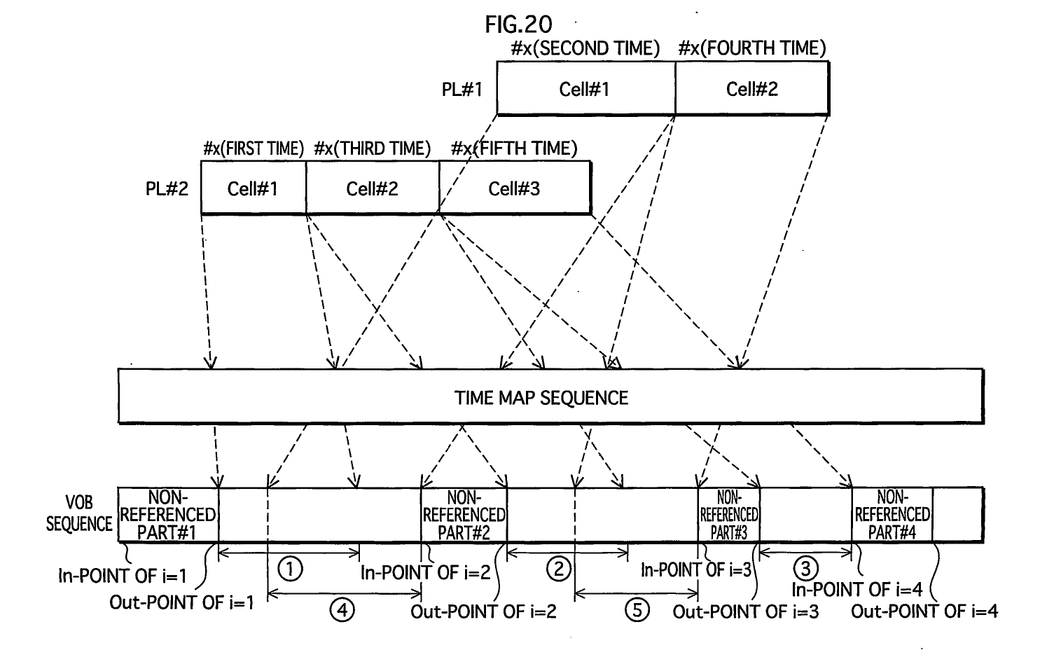

The processes performed in the above flowchart are described in greater detail, with reference to the concrete example depicted in FIG. 20. The concrete example of FIG. 20 is based on the premise of FIG. 3 and FIG. 4, in which two PLs, namely, PL#1 and PL#2 are defined on the VOB sequence. The PL#1 is made up of two cells, namely Cell#1-Cell#2. The PL#2 is made up of three cells, namely Cell#1-Cell#2-Cell#3. PL#1-Cell#1 and PL#2-Cell#1 overlap with each other. Likewise, PL#1-Cell#2 and PL#2-Cell#2 overlap with each other. The note “i=1, i=2, i=3, i=4” and the like indicates that, if the variable “i” takes a value such as 1, 2, 3, and 4, which part of the VOB sequence is extracted as non-referenced part.

In addition, the note “#x (nth time)” indicates that the cell detected as Cell#x in nth time is which cell of which PL.

If the non-referenced part extraction unit 17 performs an operation on the concrete example of FIG. 20, at Step S31, it is judged that there is no cell, within any PL, whose In-point corresponds to the front-end of the VOB sequence. At Step S33, the front-end of the VOB sequence is set as the In-point of the first non-referenced part #1. Since the cell that has the In-point nearest to this In-point is PL#2-Cell#1, at Step S34, PL#2-Cell#1 is specified as the first Cell#x. Then, at Step S35, the Out-point of the first non-referenced part (i=1) is set to be immediately before the In-point of PL#2-Cell#1.

Following this, the loop operation of Steps S37-S43 is executed. The cell that overlaps with PL#2-Cell#1 is Cell#1 of PL#1. This Cell#1 of PL#1 has Out-point which positions after Cell#2 of PL#2. Therefore, at Step S38 and at Step S44, PL#1-Cell#1 is newly set to be the second Cell#x. Since there is no overlapping cell with this Cell#1 of Pl#1, at Step S40, the point immediately after the Out-point of PL#1-Cell#1 is specified as the In-point of the second non-referenced part (i=2).

At Steps S41 and S42, PL#2-Cell#2 is set as a new Cell#x, since this cell is the cell whose In-point positions after and nearest to the In-point of the second non-referenced part. At Step S43, the point immediately before the In-point of PL#2-Cell#2 is specified as the Out-point of the second non-referenced part, then the control is moved to Step S37.

The cell that overlaps with PL#2-Cell#2 is Cell#2 of PL#1. This PL#1-Cell#2 has Out-point that positions after the Cell#2 of PL#2. Therefore at Step S42, PL#1-Cell#2 is set to be a new Cell#x. Since there is no overlapping cell with PL#1-Cell#2, at Step S40, the point immediately after the Out-point of PL#1-Cell#2 is specified as the In-point of the third non-referenced part (i=3).

The cell whose In-point positions after and nearest to the In-point of the third non-referenced part is PL#2-Cell#3. Therefore, PL#2-Cell#3 is set as the third Cell#x (Step S41, Step S42), and the In-point of PL#2-Cell#3 is set as the Out-point of the third non-referenced part (Step S43).

There is no cell that overlaps with this PL#2-Cell#3 (Step S41: No). In addition, there is no cell that positions after PL#2-Cell#3. Therefore, the Out-point of PL#2-Cell#3 is specified as the In-point of the fourth non-referenced part (i=4), and the rear-end of the VOB sequence is specified as the Out-point of the fourth non-referenced part (Step S43).

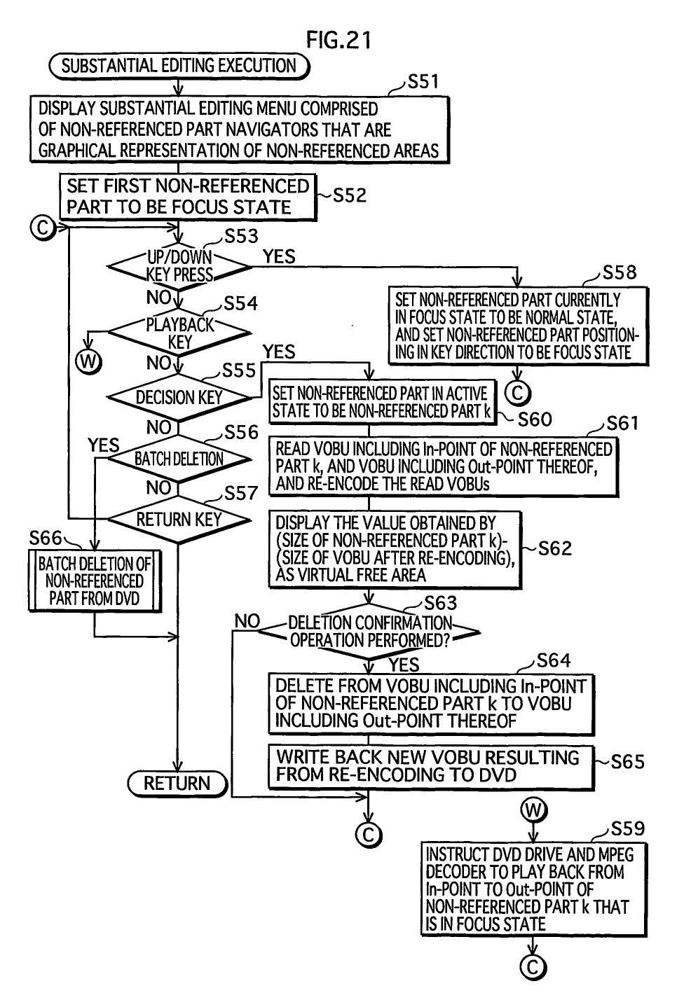

This is the end of description about the process of extracting non-referenced part. Following this, the substantial editing is described with reference to FIG. 21. FIG. 21 is a flowchart showing the process performed by the substantial editing unit 18. First, a substantial editing menu comprised of non-referenced part navigators each graphically representing a non-referenced part (Step S51). Then the top non-referenced part is set to be in a focus state (Step S52), and waits for an event to occur, such as an up/down key press (Step S53), a playback key (Step S54), a decision key (Step S55), deciding operation for a batch deletion button (Step S56), and a return key press (Step S57).

If an event of the up/down key press occurs (Step S53: Yes), then the non-referenced part currently in a focus state is set to be in a normal state, and the non-referenced part positioning in the decision key direction is set to be in a focus state (Step S58), and the control returns to an event-waiting loop comprised of Steps S53-S57. Hereinafter, the state for each non-referenced part will change while the up/down is being pressed.

If the playback key is pressed (Step S54: Yes), an operation is performed in which the non-referenced part is played back and the content of the non-referenced part is displayed to the user. Specifically, at Step S59, playback of from the In-point to the Out-point of the non-referenced part “k” that is in a focus state is instructed to the DVD drive 1 and to the MPEG decoder 4. This playback control is performed through the following processes. That is, if any of the non-referenced parts is in a focus state, and the playback key is pressed, the playback control unit 16 makes the time-address conversion unit 13 search for the start addresses respectively for the VOBU including the In-point, and the VOBU including the Out-point, based on the VOB-ID and the relative time that identifies the In-point/Out-point of the non-referenced part, and orders the DVD drive 1 to read out from the VOBU including the In-point to the VOBU including the Out-point. Then the MPEG decoder 4 is ordered to output, for the purpose of playback, from the picture data corresponding to the In-point to the picture data corresponding to the Out-point, among the read VOBUS. By doing this, the non-referenced part is displayed at the television 101, and the user can judge whether the non-referenced part is necessary or not.

If the decision key is pressed (Step S55: Yes), the non-referenced part that is in an active state is set as non-referenced part “k” (Step S60), and the VOBU including the In-point for the non-referenced part “k” and the VOBU including the Out-point of the non-referenced part “k” are read out and re-encoded (Step S61). Then, the value obtained by the expression (size of non-referenced part)−(VOBU size after re-encoding) is displayed as a virtual free area size (Step S62), then the control waits for receiving a deletion confirmation operation from the user (Step S63).

When the deletion confirmation operation from the user is received, from the VOBU including the In-point to the VOBU including the Out-point are deleted (Step S64), and new VOBUs obtained by re-encoding are written back to the DVD (Step S65).

A free area is obtained by the deletion of VOBUs at Step S64. After this, once the MPEG encoder 3 encodes a broadcast signal that the tuner 2 has demodulated, thereby obtaining a new VOB, this new VOB can be written to this free area.

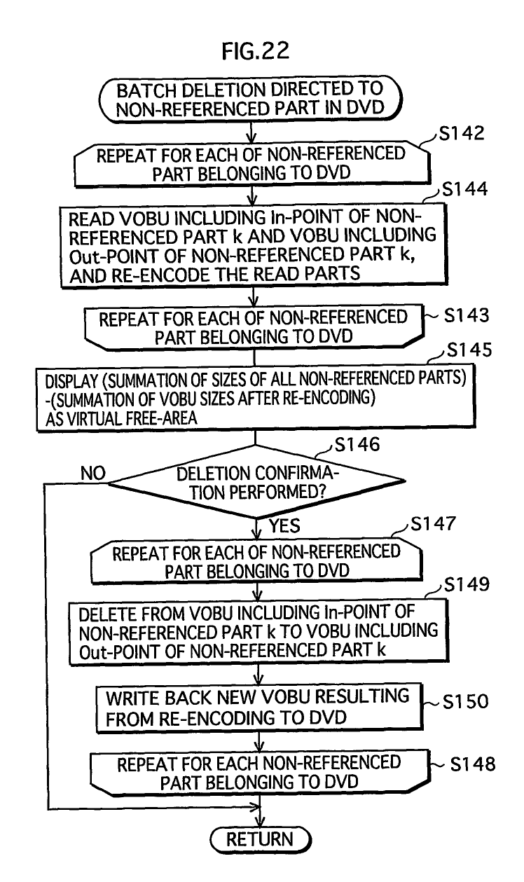

If the deciding operation for the batch deletion button for the non-referenced part is indicated (Step S56: Yes), Step S66 is performed. Step S66 has a sub-routine thereunder. FIG. 22 is a flowchart showing the process regarding this batch deletion of non-referenced part in DVD.

In this flowchart, first, the loop operation from Steps S142-S144 is performed. This loop operation is a repetition of the following processes for all the non-referenced parts included in the DVD (Steps S142, and S143). The specific processes are in which the VOBU including the In-point of the non-referenced part “k” and the VOBU including the Out-point of the non-referenced part “k” are read out, and then re-encoding is performed on the read VOBUs (Step S144).

Once this re-encoding is finished, at Step S145, the value resulting from the expression (summation of sizes of all non-referenced parts)−(summation of VOBU sizes after re-encoding) is displayed, on the substantial editing menu, as a virtual free area size.

Once the deletion confirmation operation is received from the user, and the deletion confirmation operation from the user completes, the loop operation from Steps S147-S150 is performed. Specifically, the VOBUs from the VOBU including the In-point to the VOBU including the Out-point are deleted (Step S149), and new VOBUs obtained by re-encoding, are written back to the DVD (Step S150). In the loop operation, the above operations are repeated for all the non-referenced parts belonging to a PG (Steps S147, and S148). After finishing this repetition, the control will return to the main routine.

As described above, according to the present embodiment, a plurality of non-referenced parts are displayed to a user, among which the user can select parts to be deleted. This enables selective deletion in which non-referenced parts whose preservation value is relatively low are abandoned. With this construction, it becomes possible to keep the user from regretting as much as possible, and also to allocate free spaces.

According to such a substantial editing, if there is a small deficiency in free space for the purpose of another recording, free space can be allocated by deleting some of the extracted non-referenced parts. This will prevent the opportunity of recording new broadcast contents to slip away.

### The Second Embodiment

In the first embodiment, deletion of non-referenced part is performed at the time of executing the substantial editing. This means that in the first embodiment, unless the user shows definite intention for selecting the substantial editing, deletion of non-referenced part will not be performed. It is not probable that the user, who is wishing to allocate free areas, nevertheless is not fully aware of the non-referenced parts, will choose to perform the substantial editing with a definite intention. Accordingly, it is not possible to prompt such a user to delete non-referenced part. In view of this, in the second embodiment, at the time of performing an operation for playback a PG, the user will be informed of whether there is non-referenced part for each PG. As mentioned above, the non-referenced part is a part not referenced by any PL, and so cannot be displayed at PL playback. It is only at PG playback, that such a non-referenced part is displayed. In the second embodiment, the user will be informed of whether there is non-referenced part for each PG with use of PG navigator, at the time when user shows intention to perform PG playback.

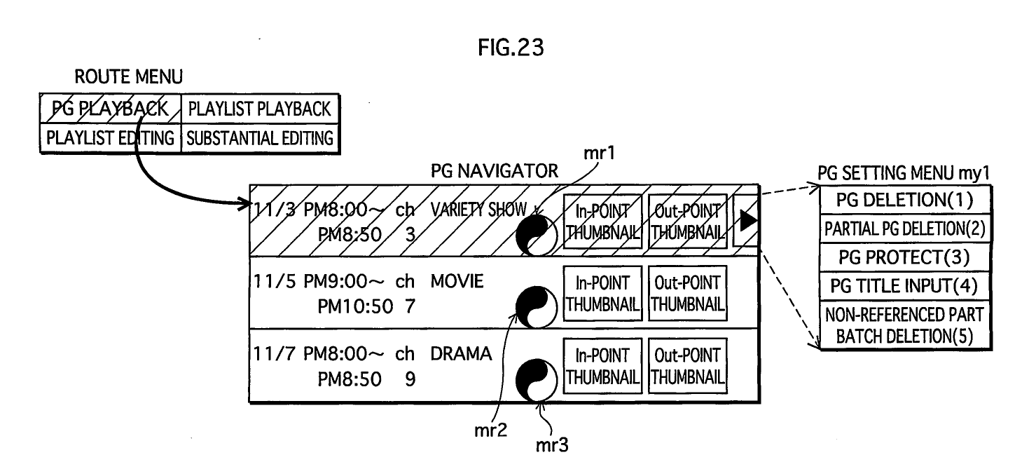

FIG. 23 is a diagram showing PG navigator relating to the second embodiment. The PG navigator relating to the second embodiment appears at the television 101 when the user has selected the PG playback in the route menu, just as in the first embodiment. The difference of PG navigator in this diagram, from that of FIG. 6 or from FIG. 8, is (i) the positive/negative marks mr1, mr2, and mr3 exist, and (ii) the setting menu my1 unique to PG can be drawn out.

The positive/negative marks mr1, mr2, and mr3 each show that there is “negative” part that symbolizes non-referenced part in the PG. The example of FIG. 23 indicates that the contents 1, 2, and 3 either have non-referenced part therein, or that the PG itself is non-referenced part.

The setting menu drawn out from each PG navigator receives selection of such as one of the following items: PG deletion (1) for deleting whole PG from the DVD; partial PG deletion (2) for deleting only a part of PG; PG protect (3) for setting the attribute of PG as deletion inhibit; title input (4) for receiving title input with regard to PG; and non-referenced part batch deletion (5) for deleting all the non-referenced parts included in PG at once. The setting menu in this diagram is for the PG navigators that are assigned a positive/negative mark. The setting menu for the PG navigators that are not assigned a positive/negative mark will have only items (1)-(4) stated above. The reason for this is that for the PG that does not have any non-referenced part, it is not necessary, from the beginning, to delete non-referenced part.

Because the non-referenced part, by definition, is a part not referenced by the PL, therefore is assumed to have low preservation value. It is likely that sooner or later, non-referenced parts are to be deleted. If these non-referenced parts are deleted prior to the PG playback, the PG is played back in a refined state without non-referenced part.

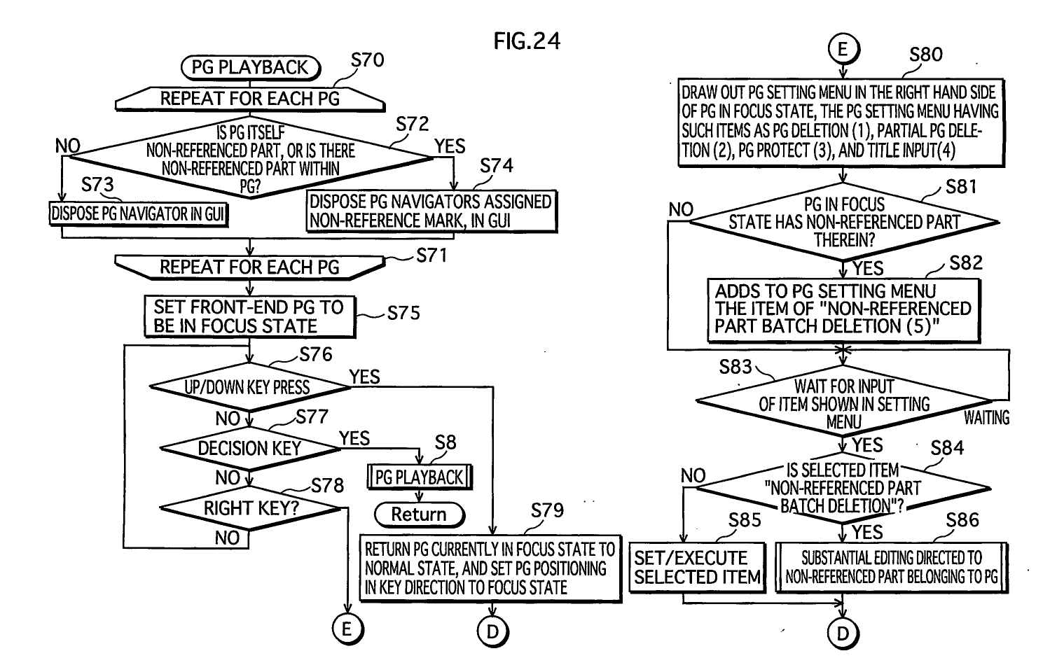

The flowchart for PG playback that relates to the second embodiment is shown in FIG. 24. This flowchart is for realizing PG playback, and is an alternative for Steps S7 and S8 of the main routine of FIG. 12.

In this flowchart, a plurality of PG navigators are displayed in the loop operation comprised of Steps S70-S75. After the front-end PG is set in a focus state at Step S75, an event is waited at the loop operation of Steps S76-S79. According to the event that has occurred after this event waiting, one of Steps S8, S79, S80-S86 is selectively performed.

The loop operation comprised of Steps S70-S74 repeats, for all the PGs recorded in the DVD, operations of: judging whether the PG itself is a non-referenced part, or there is non-referenced part within the PG (Step S72); and disposing a PG navigator without a positive/negative mark, for the PG judged not to include non-referenced part therein (Step S73), and disposing a PG navigator with a positive-negative mark, for the PG judged to include non-referenced part therein (Step S74). As a result of this loop operation of Steps S70-S74, the front-end navigator among the plurality of PG navigators is set to be in a focus state (Step S75).

The event-waiting loop of Steps S76-S77 is to, according to an up/down key press (Step S76), wait for a decision key press (Step S77), and a right key press (Step S78), while changing the state of each PG navigator (Step S79). The state change of PG navigators is to return the PG currently in focus state to normal state, and the PG positioning in the key direction to focus state. If the decision key is pressed while any of the PG navigators is in focus state, the PG in focus state is played back at Step S8.

If the right key is pressed, both of the setting menu display (Steps S80-S82) and the operation incident to the operation for this menu (Steps S83-S86) are performed.

In the setting menu display, the PG setting menu having items such as PG deletion (1), partial PG deletion (2), PG protect (3), and title input (4) is first drawn to the right hand side of the PG in focus state (Step S80), then if the PG in focus state has non-referenced part therein (Step S81: Yes), the item of “non-referenced part batch deletion (5)” is added (Step S82).

By this setting menu display, the setting menu for PGs that do not have non-referenced part therein will have PG deletion (1), partial PG deletion (2), PG protect (3), and title input (4). Whereas the setting menu for PGs that have non-referenced part therein will have non-referenced part batch deletion (5), in addition to the items (1)-(4).

In the operation that is incident to the operation for the setting menu, firstly, input for the items shown in the setting menu is waited (Step S83), and if the selected item is the non-referenced part batch deletion (5), the substantial editing directed to the non-referenced part belonging to the PG is performed (Step S86). On the other hand, if the selected item is one of the items (1)-(4), then the corresponding operation is performed (Step S85).

As described so far, by the present embodiment, the batch deletion of non-referenced part included in a PG is prompted to the user, prior to the playback of the PG. Therefore, deletion of non-referenced part is facilitated.

### The Third Embodiment

In the second embodiment, deletion of non-referenced part included in a PG is prompted when a user shows intention to play back the PG. In the third embodiment, deletion of non-referenced part included in each PG is also prompted to a user showing the intention of PG playback. The difference with the second embodiment is to provide a check box in each PG navigator, and executes deletion of non-referenced part in each PG, according to the check operation with respect to this check box.

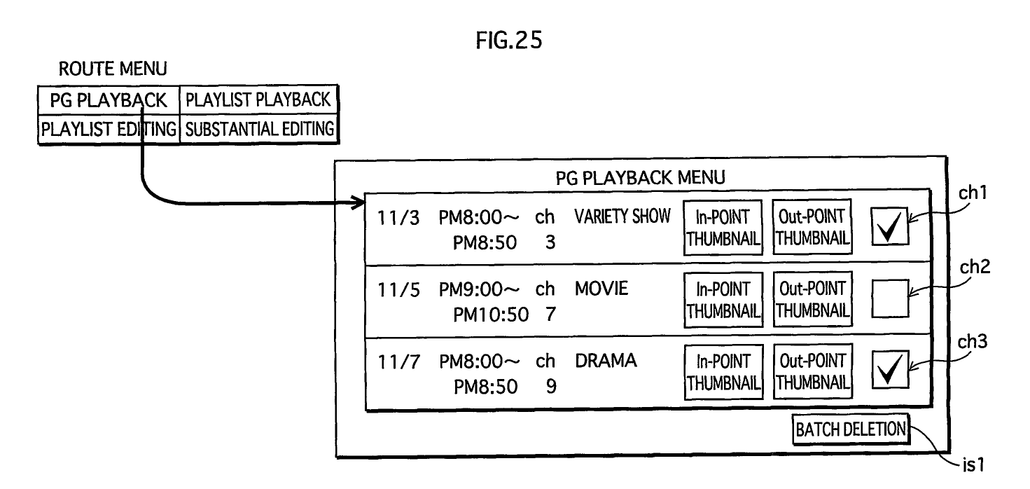

FIG. 25 is a diagram showing one example of PG navigator relating to the third embodiment. Just as in the first embodiment, the PG navigator will appear in the television 101 after the user selects PG playback in the route menu. The difference with the PG navigator shown in FIG. 23 is that, instead of the positive/negative mark, the check boxes ch1, ch2, and ch3 are provided. The check mark placed in this checkbox indicates that the user has shown his intention of deleting all the non-referenced parts within the corresponding PG. The check boxes ch1, ch2, and ch3 will be displayed for each of the PGs having non-referenced part. Therefore, if the user wants to delete the non-referenced parts in several PGs at once, all he has to do is to check the check boxes corresponding to these PGs. In this diagram, the first PG and the third PG have a check mark in their check boxes. Therefore, the non-referenced parts in the content 1 and content 3 are to be deleted at once.

The batch deletion button is1 is a GUI part assigned to such as the picture-recording key and the playback key, of the remote controller, and is for receiving the operation such as of deleting the non-referenced parts displayed in the menu, at once.

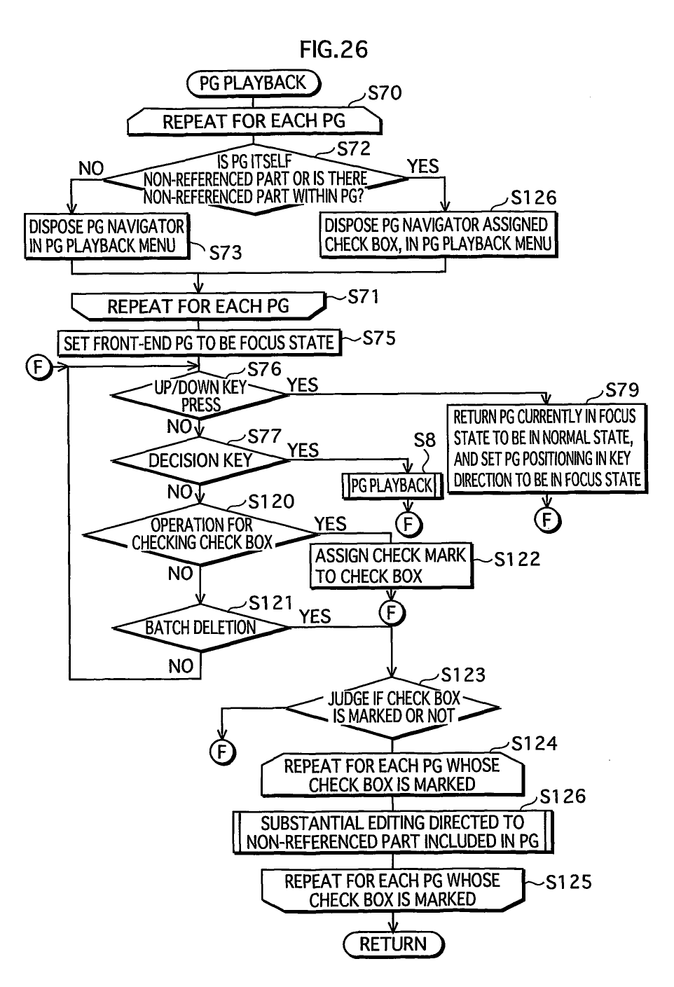

The playback operation for the PG navigators assigned the aforementioned check box is realized as described in the flowchart of FIG. 26. Hereafter, the process performed by the recording apparatus of the third embodiment is described with reference to this flowchart. The flowchart of FIG. 26 is created based on the flowchart of FIG. 24. Therefore, the steps that perform the same operation as in the flowchart of FIG. 24 are assigned the same reference number, and the description thereof is omitted.

In the flowchart of FIG. 26, a plurality of PG navigators are displayed as a result of the loop operation comprised of Steps S70-S73, and Steps S126. Then, after the front-end PG is set in a focus state at Step S75, an event is waited at the loop operation of Steps S76-S77, and Steps S120-S121. According to the event occurring after this event waiting, one of Steps S8, S79, S122, S123-S125 is selectively performed.

The loop operation comprised of Steps S70-S75 is for repeating, for all the PGs recorded in the DVD, the following operations of: judging whether the PG itself is a non-referenced part, or whether there is non-referenced part within the PG (Step S72); and disposing a PG navigator without a check box, for the PG judged not to include non-referenced part (Step S73), and disposing a PG navigator with a check box, for the PG judged to include non-referenced part (Step S126). After this loop operation of Steps S70-S73, and S126, the front-end PG navigator among the plurality of PG navigators is set to be in a focus state (Step S75).

The event-waiting loop of Step S76-S77 is for, according to an up/down key press (Step S76), waiting for a decision key press (Step S77), a check operation for the check box (Step S120), and a batch-deletion button decision operation (Step S121), while changing the state of each PG navigator (Step S79). The state change of PG navigator is to specifically return the PG currently in focus state to normal state, and to set the PG positioning in the key direction to focus state (Step S79). If the decision key is pressed when any of the PG navigators is set in a focus state, the PG in a focus state is played back at Step S8.

If a check operation is performed to the check box (Step S120), a check mark is placed in the check box (Step S122), then the control returns to the loop operation comprised of Steps S76-S77, and S120-S121.

If a batch-deletion button deciding operation is performed (Step S121: Yes), the following operations are repeatedly performed for all the PGs whose check box is checked (Steps S124, and S125). The operations are specifically for: confirming the existence of check mark in the check box (Step S123); and performing substantial editing directed to the non-referenced part included in the PG (Step S126).

As described above, according to the present embodiment, the PGs whose non-referenced part should be deleted may be collectively defined, thereby enhancing the convenience for the user.

### The Fourth Embodiment

The fourth embodiment is for prompting cleanup of non-referenced part when a recording programming is performed with respect to the recording apparatus. A recording programming is performed in response to reception from a user the input of the recording start date/time and recording end date/time. In the recording programming, once the recording start date/time, recording end date/time, and image-quality mode are set, it is possible to calculate the size necessary for the content recording. However, when the calculated size exceeds the free area size currently remaining in the DVD, conventional DVD recorders cannot perform the programmed recording. In view of this, in this fourth embodiment, after the items such as recording start date/time-recording end date/time are set and size required for the recording is calculated, the user will be prompted to delete non-referenced part, if the calculated size exceeds the free area size of the DVD.

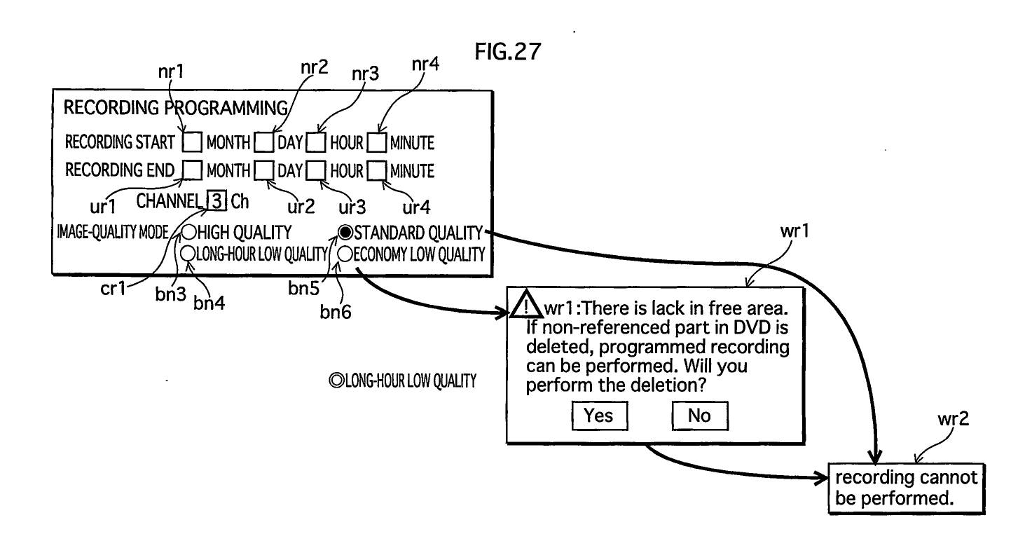

The recording programming operation is performed for the menu shown in FIG. 27. FIG. 27 is a diagram showing one example of the recording programming menu. The recording programming menu is made up of: numerical value fields nr1, nr2, nr3, and nr4, in which date/time to start recording is defined as a representation of “month” “day” “time” and “minute”; numerical value fields ur1, ur2, ur3, and ur4, in which date/time to end the recording is defined as a representation of “month” “day” “time” and “minute”; a numerical value field cr1 in which the broadcast channel to be recorded is defined as a numerical value; and buttons bn3, 4, 5, and 6, for respectively receiving one of the four alternatives of image-quality mode (i.e. 1.6 Mbps (Economy low quality), 2.4 Mbps (Long-hour low quality), 4.7 Mbps (Standard quality), and 9.5 Mbps (High quality)).

If recording programming is performed for this menu, playback time and size of the content to be recorded are obtained. When the obtained size is below the free area size of the DVD, the recording is performed according to the programming performed in this menu.

If the obtained size exceeds the free area size of the DVD, the user will be prompted to delete the non-referenced parts included in the DVD. The menu wr1 is a warning dialogue displayed when lack in free area is revealed during the recording programming. In the fourth embodiment, deletion of non-referenced part is performed when the user gives an affirmative answer to this menu. If the user answers negatively to this menu, the menu wr2 will be displayed.

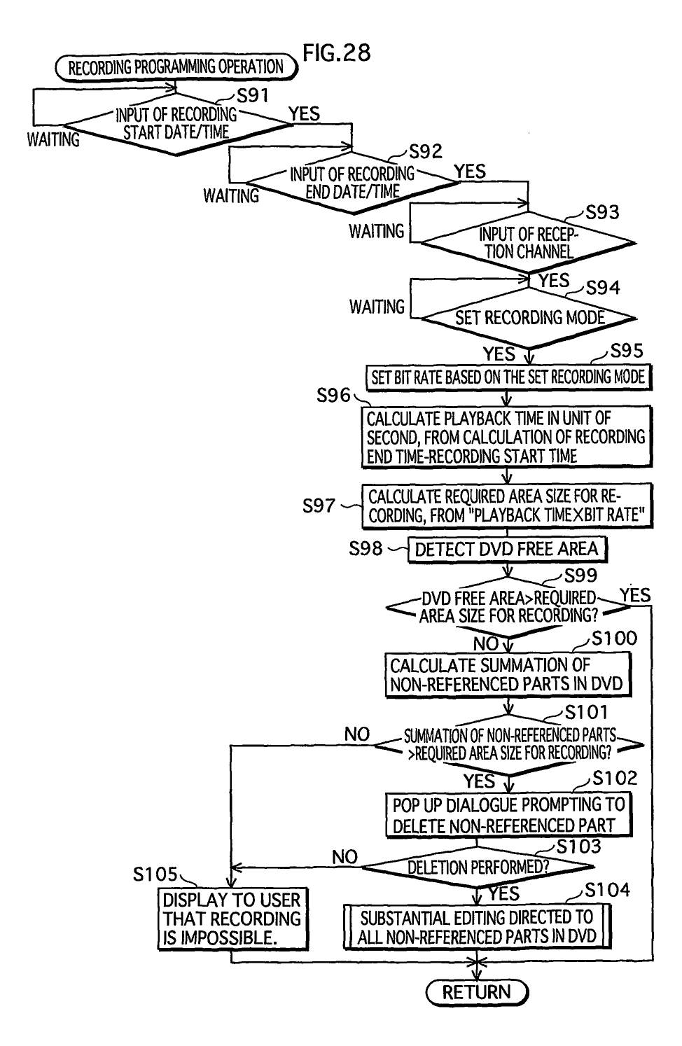

The recording programming operation for this menu of FIG. 27 is performed according to the flowchart of FIG. 28. As follows, this recording programming operation is described with reference to this flowchart.

In this flowchart, a series of operations for recording programming are performed, the series of operations including: input of recording start date/time (Step S91); input of recording end date/time (Step S92); input of reception channel (Step S93); and setting of image-quality mode (Step S94). Then, an area size necessary for performing the programmed recording is calculated (Steps S95-S97), and judgment is performed as to whether the DVD has enough free area required for the programmed recording (Steps S98-S101). After completion of the above, deletion of non-referenced part is performed when there is lack in free area in the DVD and after the confirmation of the user is received (Steps S102-S104).

Calculation of necessary area size performed at Steps S95-S97 is to set the bit rate based on the recording mode set at the menu (Step S95), calculate the playback time in the unit of second, from the calculation of “recording end date/time-recording start date/time” (Step S96), then performs calculation of “the playback time multiplied by bit rate” thereby obtaining the area size required for the recording (Step S97).

The judgment as to whether there is enough DVD free area performed at Steps S98-S101 is to serially perform the following: a judgment as to whether the DVD free area exceeds the required area size for recording (Step S99); and a judgment as to whether the summation of non-referenced parts is below the required area size for recording (Step S101).

If at Step S99 the DVD free area size is judged to exceed the required area size for the recording, the control returns to the main routine from the operations in this flowchart. Judgment of Step S101 is only performed when the DVD free area size is below the required size for recording.

Specifically, when the DVD free area size is below the required area size for recording, the summation of non-referenced parts in the DVD is calculated (Step S100), and at Step S101, judgment is performed as to whether the summation of non-referenced parts is below the required area size for recording. If the summation is judged to exceed the required size for recording, the dialogue prompting the deletion of non-referenced parts is popped up (Step S102), so as to confirm the user of the deletion (Step S103). If the user agrees with performing of this deletion, all the non-referenced parts in the DVD are deleted (Step S104).

If the summation of non-referenced parts exceeds the required area size for recording, and if the user does not agree with performing of the deletion, the user will be notified that it is impossible to perform the recording at Step S105.

As described above, according to the present embodiment, deletion of non-referenced part is prompted, if the user shows intention of recording programming, and that there is lack in free area in the DVD. This construction facilitates cleanup of non-referenced parts.

### The Fifth Embodiment

The fifth embodiment discloses a recording apparatus capable of performing environment setting. This environment setting performed by the recording apparatus is to receive a setting of a minimum size of free area that the user wants to allocate, and to store the minimum size as the environment setting. The recording apparatus keeps monitoring the free area size that the DVD currently has. If the free area size falls below this environment setting, the recording apparatus pops up a warning dialogue, thereby prompting deletion of non-referenced part.

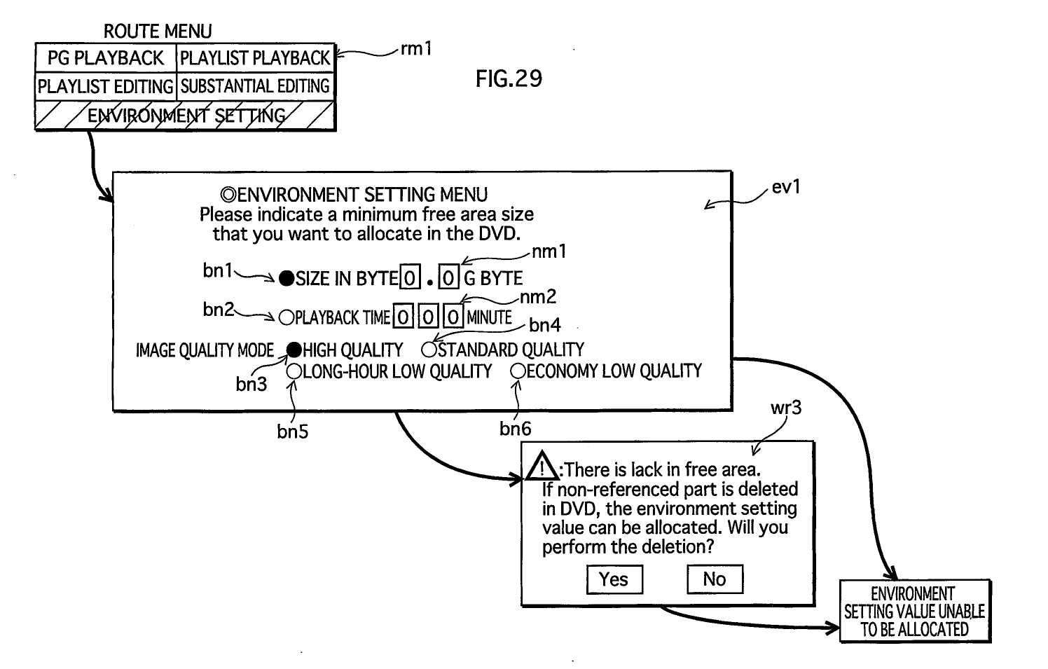

Environment setting performed by a user will be done for the environment setting menu shown in FIG. 29. FIG. 29 is a diagram showing one example of menu used in the fifth embodiment.

The route menu rm1 in FIG. 29 includes the item of “environment setting”, in addition to “PG playback”, “PL playback”, “playlist editing”, and “substantial editing” that the first embodiment has. The environment setting menu will be displayed when this “environment setting” is selected at the route menu rm1.

The environment setting menu ev1 includes: buttons bn1 and 2, for receiving selection of two alternatives of specification by byte size and specification by time; a numerical value input field nm1 for receiving specification of size of area to be allocated in the unit of byte; a numerical value input field nm2 for receiving specification of playback time in the unit of minute; and buttons bn3, 4, 5, and 6, for respectively receiving one of the four alternatives of image-quality mode (i.e. 1.6 Mbps (Economy low quality), 2.4 Mbps (Long-hour low quality), 4.7 Mbps (Standard quality), and 9.5 Mbps (High quality)). The input operation directed to the buttons and the numerical value fields is performed based on the flowchart of FIG. 14.

The warning dialogue wr3 is displayed when the environment setting value set in the environment-setting menu cannot be allocated.

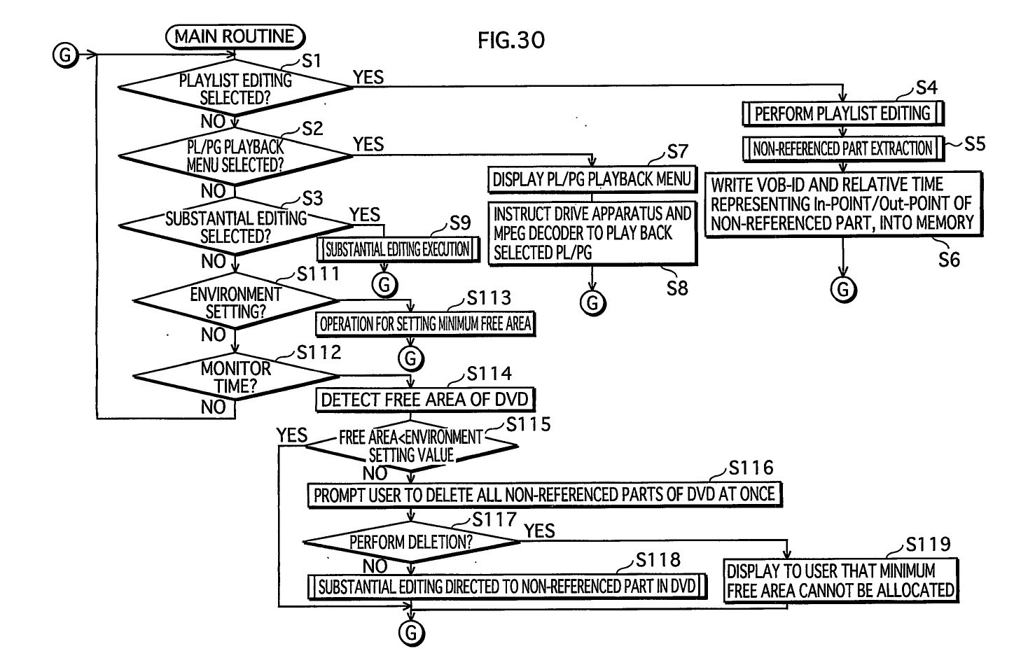

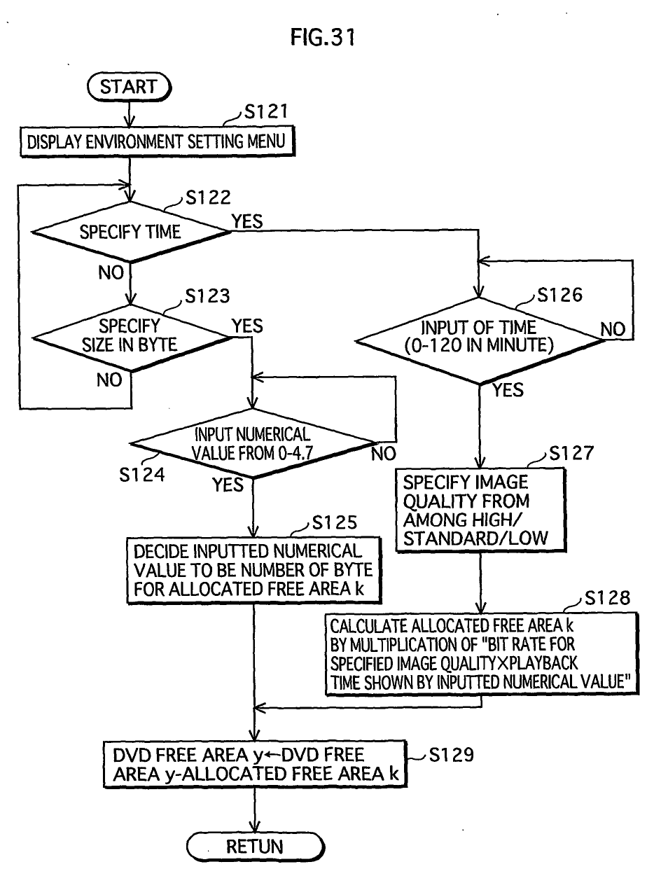

The process performed by the recording apparatus in the fifth embodiment is shown in the flowcharts of FIGS. 30 and 31. As follows, the process performed by the recording apparatus of the fifth embodiment is described with reference to these flowcharts. The flowchart of FIG. 30 corresponds to the main routine, and is based on the flowchart of FIG. 12 that is for the first embodiment. Since being based on FIG. 12, the flowchart of FIG. 30 shares the same steps. As follows, the same steps are assigned the same reference number, and the description thereof is omitted.

The flowchart of FIG. 30 executes the loop operation comprised of Steps S1-S3, and S111-S112. Once the environment setting is selected (Step S111: Yes), input of environment setting is received, in accordance with the flowchart of FIG. 31.

In the flowchart of FIG. 31, the area allocation menu of FIG. 29 is displayed first at Step S121, and then the control is moved to the loop operation of Steps S122-S123. If the button bn1 for specifying the byte size is clicked (Step S123), numerical value input is made to be effective which enables input of numerical value from among 0-4.7 in the numerical value input field nm1 (Step S124), and the inputted numerical value is interpreted as the minimum free area size k (Step S125).

If the button bn2 for specifying time is clicked (Step S122), numerical value input from among 0-120 minutes is made to be effective in the numerical value input field nm2 (Step S126). After the input is performed therein, the image-quality mode buttons bn3-6 are made to be effective, which are for selecting one of the four image-quality mode alternatives (Step S127). Then when a playback time and an image-quality mode are specified, the minimum free area size k is calculated by the multiplication of “bit rate of the specified image quality and the playback time corresponding to the numerical value inputted” (Step S128). The free area size calculated in the above way is stored as an environment setting.

When it reaches the monitor time that the timer has set in advance in the loop operation comprised of Steps S1-S3, and S111-S112, the free area size in the DVD is detected (Step S114), and the judgment as to whether the free area size in the DVD exceeds the environment setting value. If the size is judged to exceed the environment setting value, the control returns to the loop operation comprised of Steps S1-S3, and S111-S112.

If the size is judged not to exceed the environment setting value, batch deletion is performed for the non-referenced parts within the DVD, if the deletion execution is selected (Step S118). If the deletion execution is not selected, it is displayed to the user that the minimum free area size cannot be allocated (Step S119).

As described in the above, according to the present embodiment, the setting of the free area size in the DVD is received from a user as an environment setting, and the user will be prompted to delete non-referenced part when the actual free area size falls below this environment setting value. Therefore it becomes possible to facilitate cleanup of non-referenced part.

### The Sixth Embodiment

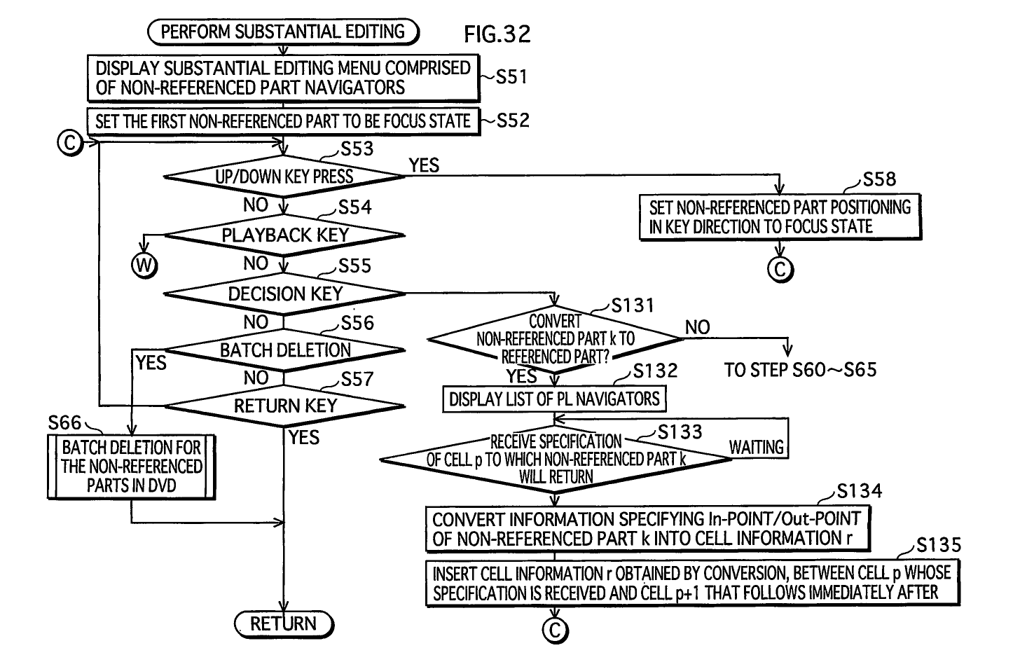

The substantial editing of the first embodiment only deletes non-referenced part. However, non-referenced part sometimes includes contents worthy of being preserved. Users often notice its value during the substantial editing. In view of this, the sixth embodiment performs operation so as to incorporate a non-referenced part into the PL when a user notices the preservation value of the non-referenced part during the substantial editing. FIG. 32 is a flowchart showing the operation performed by the substantial editing unit 18 relating to the sixth embodiment. In this flowchart, what are new are as follows. That is, Step S131 is inserted between Step S55 and Step S60, and an instruction is received from a user as to whether the non-referenced part k in a focus state should be converted into a referenced part (i), and if the user answers affirmatively, the operation of Steps S132-S135 is performed (ii).

As follows, the operation of Steps S132-S135 in FIG. 32 is described. At Step S131, if the user performs an operation for converting the non-referenced part k in a focus state into a referenced part, the substantial editing unit 18 displays a list of PL navigators (Step S132). This operation is for prompting the user to define the position to which the non-referenced part is to be returned. After the display of PL navigators, specification of a cell to which the non-referenced part k will be returned is received (Step S133). Following this, the information specifying the In-point/Out-point of the non-referenced part k is converted into cell information r (Step S134), and the cell information r obtained by the conversion is inserted between the cell p whose specification is received and the cell p+1 that follows immediately after (Step S135). According to the processes described above, the non-referenced part whose preservation value was noticed during substantial editing is incorporated as a member of the PL.

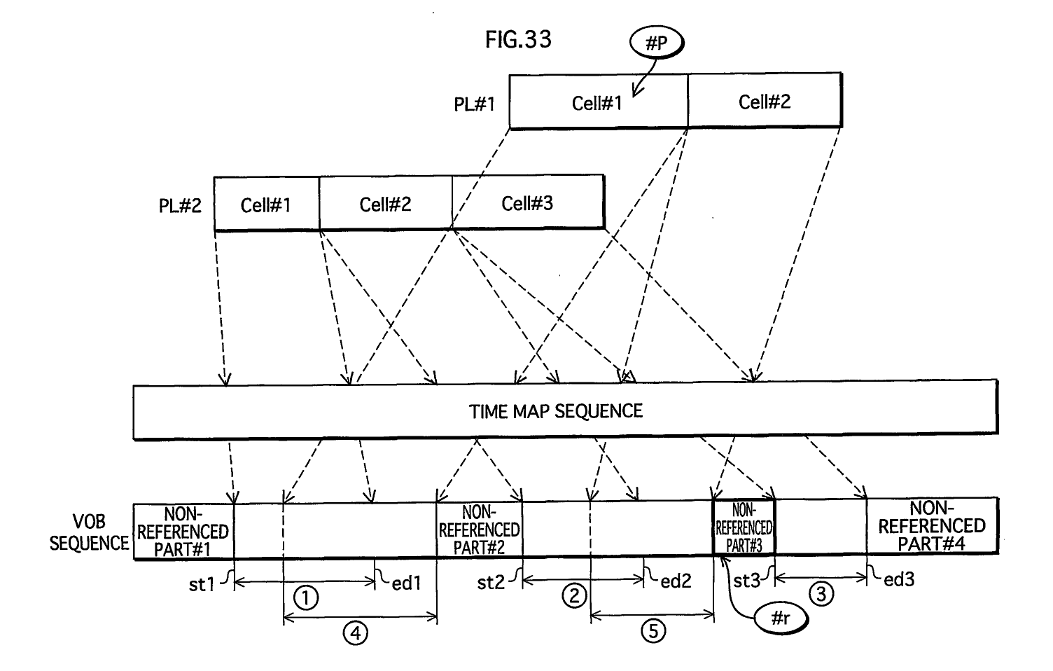

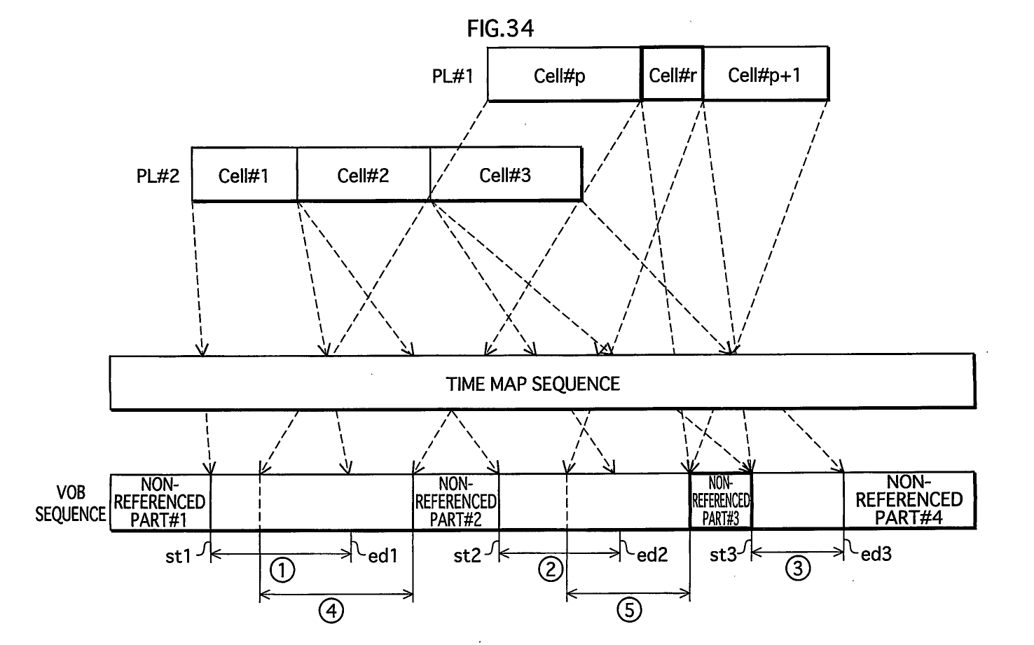

As follows, with reference to the concrete examples in FIG. 33 and FIG. 34, the operation performed by the substantial editing unit 18 of the sixth embodiment is described. In this FIG. 33, suppose the non-referenced part #3 is defined as the non-referenced part #r, and that the Cell#1 of the PL is specified as a cell in which this cell information #r is to be inserted. In this case, the Cell#1 of the PL is specified as cell information #p, and the Cell#2 is specified as cell information #p+1. Then, as shown in FIG. 34, the cell information of the cell #r is generated from the information specifying the In-point/Out-point of the cell information #r, and thus generated cell information #r is inserted between the cell information #p and the cell information #p+1. By doing this, part of the VOB never having been referenced by any PL so far can be included as a member of a PL.

As described above, according to the present embodiment, it is possible to convert the non-referenced part that the substantial editing unit 18 has extracted, into cell information, thereby including the cell information as a member of a PL. Therefore the convenience of editing will be enhanced.

### The Seventh Embodiment

The seventh embodiment is for executing so-called “undo function” of editing. To realize this undo function, the recording apparatus that relates to the seventh embodiment is equipped with a nonvolatile memory, and the substantial editing unit 18 obtains, in this memory, the backup of from the VOBU including the In-point of the non-referenced part to the VOBU including the Out-point of the non-referenced part. By retaining the backup in the nonvolatile memory, it becomes possible to restore the deleted non-referenced part to the DVD, unless the contents of the nonvolatile memory are deleted.

The substantial editing unit 18 displays the button for undo function on the substantial editing menu, and writes back the VOBU from the nonvolatile memory to the DVD, in response to a press of this button. According to this construction, non-referenced parts having been once deleted can be restored to the DVD.

As described above, according to the present embodiment, non-referenced part is deleted after being saved to the nonvolatile memory. Therefore, if the user notices the value of the deleted non-referenced part, the part can be restored to the DVD.

In addition, only the non-referenced part having been actually deleted are backed up for the undo function, meaning that not all the plurality of non-referenced parts should be retained in the memory. Therefore, an undo function can be executed even when the nonvolatile memory for backup has a small capacity.

### The Eighth Embodiment

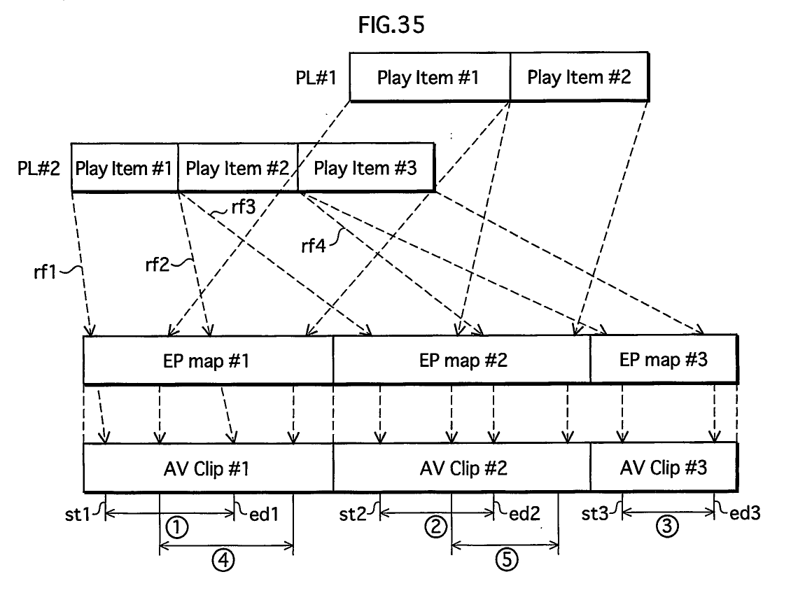

Each recording apparatus relating to from the first to seventh embodiments records a moving image stream in the MPEG-PS format, to the DVD being a recording medium. As opposed to this, the eighth embodiment relates to improvement in recording a moving image stream into a recording medium, in accordance with the MPEG2-TS (transport stream) format. In the eighth embodiment, the recording medium that is the used in recording a moving image stream is BD-RE. FIG. 35 shows the data structure of a moving image stream to be recorded in a BD-RE, in the same notation system used for FIG. 3.

AVClip (in the drawing, AVClip#1, #2, and #3) is a moving image stream in the format of MPEG2-TS, which is an alternative for VOB. The AVClip is comprised of a plurality of access units. Each access unit contains a GOP. Since each access unit contains a GOP therein, it becomes possible to make random access to any beginning of each access unit. Because the moving image stream is recorded in the MPEG2-TS format, the recording apparatus has to, in playback, first convert the moving image stream into MPEG-PS format, before supplying to the audio decoder 6 and to the video decoder 7.

PlayItem (in the drawing, PlayItem#1, #2, and #3) is information that is an alternative for Cell, and specifies starting/ending points of playback sections, with reference to time information.

EP_map (in the drawing, EP_map #1, #2, and #3) is information that is an alternative for time map, and shows the playback start time of each access unit in association with the address. The playback start time of an access unit is represented as a timestamp (presentation timestamp) for the picture data positioning at the beginning of the access unit. In addition, the address of an access unit is represented as the serial number of the PES packet (SPN (serial packet number).

It can be understood that, also with the moving image stream in MPEG2-TS format, it is possible to define a playback path comprised of one or more playback sections. This inevitably results in generation of non-referenced part, just as in the first embodiment.

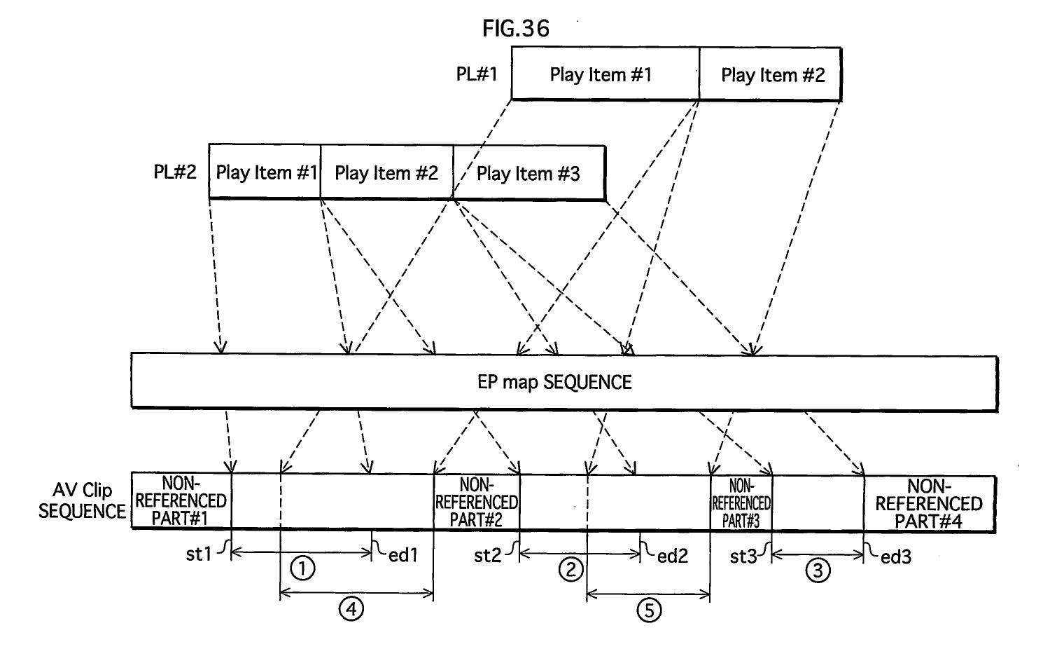

FIG. 36 is a diagram showing the non-referenced parts resulting in the example of FIG. 35. If such non-referenced parts are generated, the non-referenced part extraction unit 17 extracts the non-referenced parts, in the same procedures as in the first embodiment, thereby displaying the parts to the user to prompt the deletion thereof.

As described above, according to the present embodiment, it becomes possible to display the non-referenced parts of the moving image stream written into the recording medium even in the MPEG2-TS format, thereby prompting deleting thereof to the user. Therefore, even with recording apparatuses that can be used in digital broadcast, it becomes possible to produce the same effect as in the first to seventh embodiments.

### The Ninth Embodiment

The ninth embodiment is improved version of the eighth embodiment. Specifically, the improved made in the ninth embodiment is to take into account the increase in size incident to the bridge part, in calculation of the virtual free area.

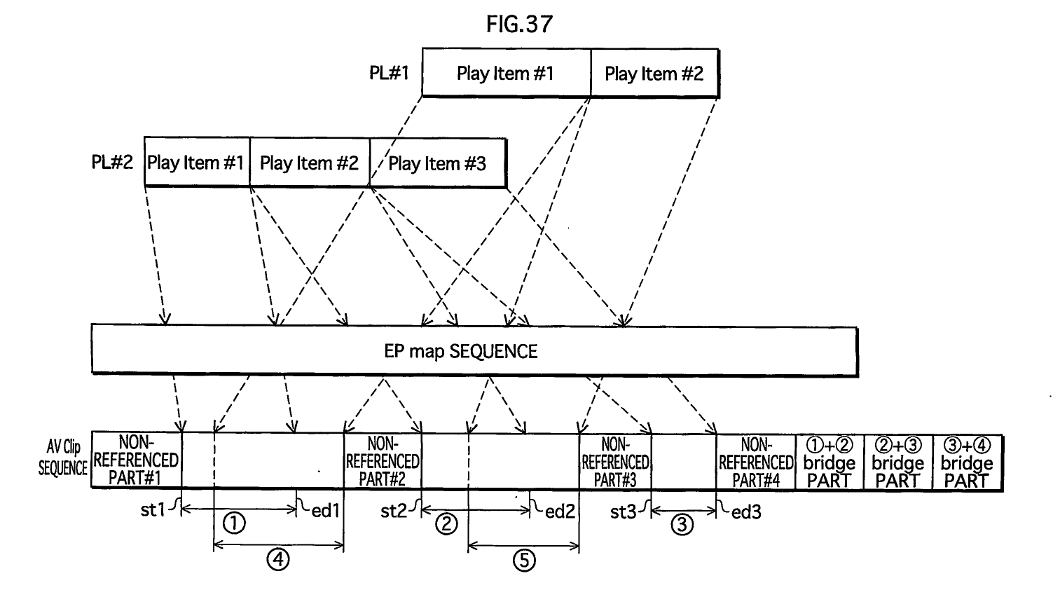

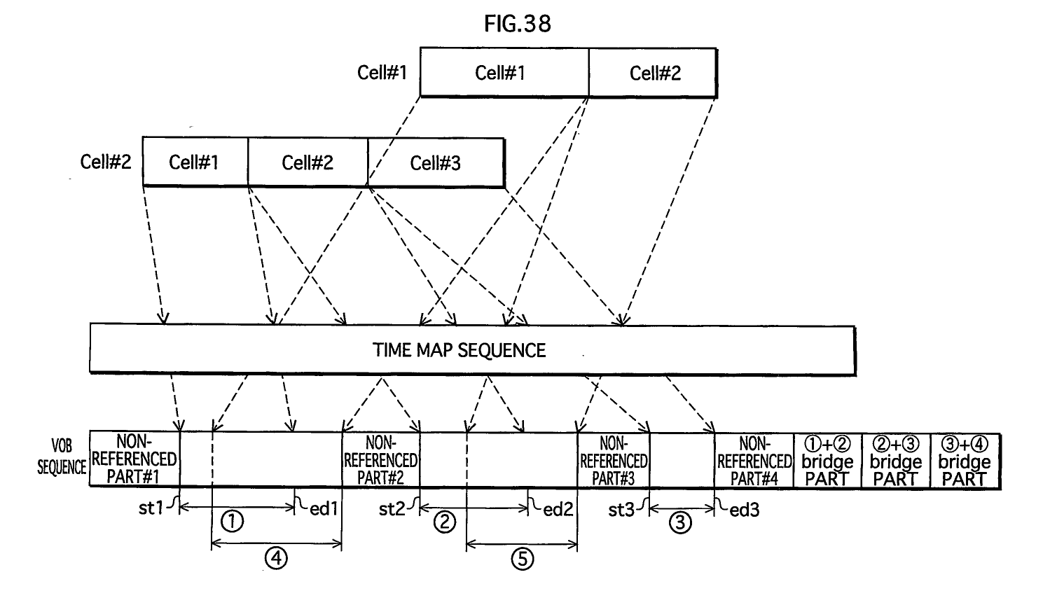

The bridge part is comprised of a copy part of the rear-end of the preceding playback section, and a copy part of the front-end of the succeeding playback section, and is re-encoded so as to yield seamless connection. FIG. 37 is a diagram showing the bridge parts created for the moving image stream of FIG. 36. In this diagram, the following are recorded in a BD-RE: a bridge part of playback section (1)-playback section (2); a bridge part of playback section (2)-playback section (3); and a bridge part of playback section (4)-playback section (5). Here, each set of rear-end/front-end is defined as follows. That is, from the access unit including the Out-point of the preceding playback section among the preceding VOB#x to the second access unit are defined as the rear-end. And the access unit including the In-point of the succeeding playback section, among the succeeding VOB#x+1, is defined as the front-end. The reason for defining the front-end and the rear-end in such a way is shown in the prior art U.S. Pat. No. 6,148,140 applied by the same applicant as the present application. Therefore please refer to this reference for the details.

There will be increase in size as a result of such a bridge part. Therefore in the ninth embodiment, the value obtained by subtracting the size of the bridge part from the size of the non-referenced part is displayed to the user.
i.e. (data size of non-referenced part)−(size of bridge part)

The value resulting from the above calculation is displayed as a virtual free area size.

As described above, according to the present embodiment, the virtual free area that takes into account the size increase incident to the bridge part is displayed to the user. This will enhance the accuracy of the virtual free area size.

Seamless connection information is desirably set in the bridge part created for seamless connection. The seamless connection information is information including: playback start time of the first video frame, playback end time of the last video frame, start time of audio gap, time length of audio gap, and position information of audio gap. If this seamless connection information is defined, the difference in time stamps respectively for the two sections (namely, “STC-Offset”) can be calculated from the playback start time of the first video frame, and the playback end time of the last video frame, and the calculated STC-Offset can be set in the playback apparatus. In addition, if audio decoder control is realized by referring to information on audio gap, interruption of audio incident to playback from one section to another can be prevented.

A bridge part may also be provided, with respect to the VOB recorded in the DVD-Video recording standard. FIG. 37 is a diagram showing the bridge part generated for the VOB of FIG. 4. Also in the first to seventh embodiments, it is possible to calculate a more accurate virtual free area size, if these embodiments take into account the size increase due to the bridge part in calculation of the virtual free area size.

### The Tenth Embodiment

From the first to ninth embodiments, the part not referenced by the PlayList is extracted as non-referenced part. However in this tenth embodiment, from among a moving image stream, the part that a user played back for more than twice is to be specified in the PlayList. Then, the parts resulting from subtracting the part specified in the PlayList from the entire moving image stream is extracted as non-referenced parts.

That is, the part that the user played back for more than twice is considered having high preservation value. In the tenth embodiment, such a part is specified in the PlayList. On the other hand, parts either played back once, or not played back at all have a great possibility of being deleted in the future. Therefore the tenth embodiment extracts such parts as non-referenced part.

Such an extraction will leave only necessary parts in the recording medium, among the moving image streams in the user's stock. This will facilitate cleanup of non-referenced part.

Note that “twice” used here is one example, and the standard occurrence may be third times, fourth times, for example.

### Supplementary Note for the First to Tenth Embodiments

So far, the present invention has been described by way of embodiments. However, these embodiments are only system examples that are expected to have the best possible effects in the present state of the art. Needless to say, the present invention may be realized with changes and modification, which are not depart from the essence of the invention. The representative examples of such changes and modifications include the following (A), (B), (C) . . . .

(A) The recording apparatus of each embodiment is used by being connected to the television 101. However, the recording apparatus may be integrated into a liquid crystal display, and the like. The recording apparatus may alternatively be included in such as a digital television that includes a recording medium therein. In addition, the recording apparatus of the first embodiment includes therein a DVD drive 1 and an MPEG decoder 4. However, this recording apparatus may be connected to these DVD drive 1-MPEG decoder 4, via an IEEE1394 connector, instead of including the mentioned units therein. Furthermore, in the recording apparatus in each embodiment, only the system LSI that is the essential part for performing the processes can be considered a recording apparatus.

Since these recording apparatuses each are an invention described in the description, the act of producing such recording apparatuses having the internal structure of the recording apparatuses of the embodiments is an act of implementing the invention described in the present specification. In addition, any act of transferring either with or without charge (i.e. for sale or as a gift), renting, or importing, constitutes an act of implementing the present invention. Any act of offering the mentioned transferring, renting and the like, to users in general, such as by exhibition at the shop, through catalogue solicitation, and by distribution of pamphlets, also constitutes an act of implementing the recording apparatus in this invention. (B) The information processing by way of the programs shown in FIGS. 12, 13, 14, 21, 22, 24, 26, 28, 30, 31, and 32 is concretely realized using the hardware resources such as a CPU, an MPEG decoder, and a DVD drive. Specifically, the recording apparatuses of the first to seventh embodiments are constructed as a result of the information processing for the purpose of deleting non-referenced part, which is performed by a concrete means that is realized by cooperation between the programs and the hardware.

Since the information processing by way of a program is concretely realized with use of the hardware resource, the programs whose processes are shown in FIGS. 12-32 are considered creation of technical idea using a rule of nature, and so each program, by itself, can be considered a separate invention. Since each program itself is an invention, the program is considered a specified invention, and each recording apparatus relating to the present invention is considered a product invention whose main part is the corresponding program being the specified invention.

In each embodiment, the program described is to be used as the main part of the recording apparatus relating to the present invention. However, since the program itself is an invention, the program can be implemented in the state of being separated from the recording apparatus. The act of implementing each program by itself includes: (1) act of producing the program, (2) act of transferring the program with or without charge, (3) act of renting, (4) act of importing, (5) act of providing the general public with the program via an interactive electric communication circuit, and (6) act of offering transfer or renting of the program, to users in general, such as by exhibition at the shop, through catalogue solicitation, and by distribution of pamphlets.

The categories of the aforementioned (2) transferring act and (3) renting act include an act of distributing, in the market, the program recorded in a recording medium, and an act of providing the general public with the program via the one-way broadcast network.

The category of (5) providing act via an interactive electric communication circuit includes: a case that a provider sends the program to a user, for allowing the user to use the program (program download service); and an act of providing only the function of the program via an electric communication circuit for allowing the user to use the function, while keeping the program itself at the hand of the provider (function-providing type ASP service).

(C) In the flowcharts of FIGS. 12, 13, 14, 21, 22, 24, 26, 28, 30, 31, and 32, the time concept, which each step executed chronologically has, is supposed to be an indispensable item for specifying the present invention. By chronologically executing the process of each step in the flowcharts, deletion of non-referenced part, which is the original purpose of the invention, and further the production of certain action and effect relating thereto, are realized. Therefore, the methods described in the flowcharts of FIGS. 12-32 are considered creation of technical idea using a rule of nature, and each of the methods is considered as an invention by itself. Accordingly, if the processes of these flowcharts are executed, so as to delete non-referenced part, which is the original purpose of the invention, thereby producing certain action and effect, this act corresponds to an act of implementing the recording method relating to the present invention.

(D) In the description flow of each embodiment, the recording medium in which contents are recorded is considered a DVD. However, the physical nature of this DVD does not contribute to the exertion of action and effect of the present invention so much. In view of this, other recording media having a capacity to record contents can be equally used in place of DVD. Needless to say, the representative of the recording media are optical disks other than DVD, such as CD-R, CD-RW, Blue-ray Disc. Alternatively, optical magnetic disks such as PD, and MO may be used. Furthermore, semiconductor memory cards such as a SD memory card, a compact flash card, smart media, a memory stick, a multimedia card, and a PCM-CIA card may be equally used. Moreover, magnetic recording disks such as SuperDisk, Zip, and Clik!, and removable hard disk drives such as ORB, Jaz, SparQ, SyJet, EZFley, and a microdrive may be equally used too.

(E) The contents in the embodiments may be obtained by encoding analogue/digital video signals recorded in videotape. Alternatively, the contents may be obtained by encoding analogue/digital video signals directly taken into from a video camera. In addition, the contents may be digital work such as movie distributed in the state prestored in a recording medium, and digital work distributed by a distribution server.

In addition, the content in each embodiment may be one unit of broadcast program defined by a broadcast station.

(F) In the first embodiment, the VOBU including In-point and the VOBU including Out-point are re-encoded. However, it is still effective, without performing the mentioned re-encoding, to only delete VOBUs positioning between the In-point-including VOBU and the Out-point-including VOBU. In such a case, care should be taken to leave, in the DVD, the VOBUs that are to be played back in synchronization with the picture data within the Out-point including VOBU, and the VOBUs that have dependency relation with the picture data within the In-point including VOBU, and only to delete other VOBUs. If the VOBUs mentioned to be left in the DVD are deleted, it is possible to have interruption in playback of picture data or in audio.

(G) In the non-referenced part navigators, thumbnails are displayed that relate to the In-point and the Out-point of a non-referenced part. Alternatively, however, picture data positioning midway through a non-referenced part may be displayed as a thumbnail.

In addition, a plurality of pieces of picture data may be selected from a non-referenced part in a predetermined time interval, and a plurality of thumbnails corresponding thereto may be displayed in a non-referenced part navigator. The user will be able to recall the contents of the non-referenced part more clearly, by this construction of displaying a plurality of thumbnails in a non-referenced part navigator.

(H) In each embodiment, a video stream and an audio stream are multiplexed into a VOB. However, other information may be also multiplexed thereto, the other information including sub-picture stream in which characters of subtitles are compressed in run-length method, and other control information. In addition, the MPEG encoder 3 and MPEG decoder 4 are a codec in MPEG2 image decoding/decompressing method, but may alternatively be other decoding codecs in image decoding/decompressing method that are different from MPEG2, such as MPEG1 and MPEG4.

(I) In the first to seventh embodiments, the selection operation for PG/PL performed by a user is received via a remote controller. However, specification by a user may be received via a front panel of a playback apparatus, too. Alternatively, specification by a user may be received via input apparatuses such as a keyboard, a touch panel, a mouse and a pad, and a track ball. In this case, the user specification may be received through such as a click operation and a drug operation.

### INDUSTRIAL APPLICABILITY

A recording apparatus relating to the present invention attempts to maintain free area in a recording medium, while making use of merits of playlist editing. The recording apparatus thereby heightens commercial value of a DVD recorder, an HD recorder, and the like, and so helps introducing attractive goods in the market. The recording apparatus therefore has a possibility of being of great use in the consumer goods industry.

1. A recording apparatus that writes a video stream to a recording medium and edits the video stream, the recording apparatus comprising:
an editing unit operable to specify, in accordance with a user operation, a plurality of parts of the video stream as playback sections;
a display unit operable to display to the user, a plurality of parts that remain after the playback sections are subtracted from the video stream, as non-referenced parts; and
a deletion unit operable to delete at least one of the displayed non-referenced parts from the recording medium, according to a user operation.

2. The recording apparatus of claim 1, wherein each of the playback sections is represented by a set of starting/ending positions of a playback operation, and the plurality of non-referenced parts include a part from a front-end of the video stream to immediately before a starting position of one of the playback sections that appears first, and a part from immediately after an ending position of one of the playback sections that appears last to a rear-end of the video stream.

3. The recording apparatus of claim 2, wherein
the non-referenced parts include every part immediately after one of the playback sections to immediately before another of the playback sections that follows.

4. The recording apparatus of claim 1, wherein
the display performed by the display unit is one of: sequential playback of a plurality of pieces of picture data included in the non-referenced parts; and disposing, on a screen, of a plurality of thumbnails each corresponding to the pieces of picture data.

5. The recording apparatus of claim 1, wherein
a plurality of video streams are written to the recording medium, each stream being classified into two or more contents, and the deletion unit deletes only non-referenced parts included in a certain content.

6. The recording apparatus of claim 5, further comprising:
a list-display unit operable to display a list of the contents in the recording medium; and
a reception unit operable to receive, from the user, specification of the certain content whose non-referenced parts are to be deleted, wherein
the non-referenced parts deleted by the deletion unit are included in the certain content whose specification has been received by the reception unit.

7. The recording apparatus of claim 6, wherein
a number of contents whose specification is to be received by the reception unit is two or more.

8. The recording apparatus of claim 1, further comprising:
a reception unit operable to receive, from the user, an operation for programming a recording; and
a calculation unit operable to calculate an area size required for the programmed recording, wherein
the display unit performs the display, only if the calculated area size exceeds a free area size of the recording medium, and the display unit further displays a message making an inquiry to the user about whether the non-referenced parts should be deleted.

9. The recording apparatus of claim 1, further comprising:
a reception unit operable to receive, from the user, specification of an environment setting value, the environment setting value being a minimum free area size that the recording medium should allocate, wherein
the display unit performs the display, only if the calculated area size exceeds a free area size of the recording medium, and the display unit further displays a message making an inquiry to the user about whether the non-referenced parts should be deleted.

10. The recording apparatus of claim 1, further comprising:
a backup unit operable to record therein a backup of the non-referenced parts, prior to the deletion performed by the deletion unit;
an inquiry unit operable, after the deletion performed by the deletion unit, to make an inquiry to the user about whether an undo operation should be performed; and
a write back unit operable, if the user's answer to the inquiry is affirmative, to write back the backup recorded in the backup unit to the recording medium.

11. A computer-readable program that makes a computer write a video stream to a recording medium and edit the video stream, the program making a computer perform a procedure comprising:
an editing step of specifying, in accordance with a user operation, a plurality of parts of the video stream as playback sections;
a display step of displaying to the user, a plurality of parts that remain after the playback sections are subtracted from the video stream, as non-referenced parts; and
a deletion step of deleting at least one of the displayed non-referenced parts from the recording medium, according to a user operation.

12. The program of claim 11, wherein
each of the playback sections is represented by a set of starting/ending positions of a playback operation, and the plurality of non-referenced parts include a part from a front-end of the video stream to immediately before a starting position of one of the playback sections that appears first, and a part from immediately after an ending position of one of the playback sections that appears last to a rear-end of the video stream.

13. The program of claim 12, wherein
the non-referenced parts include every part immediately after one of the playback sections to immediately before another of the playback sections that follows.

14. The program of claim 11, wherein
the display performed at the display step is one of: sequential playback of a plurality of pieces of picture data included in the non-referenced parts; and disposing, on a screen, of a plurality of thumbnails each corresponding to the pieces of picture data.

15. The program of claim 11, wherein
a plurality of video streams are written to the recording medium, each stream being classified into two or more contents, and at the deletion step, only non-referenced parts included in a certain content are deleted.

16. The program of claim 15, wherein the procedure further comprises:
a list-display step of displaying a list of the contents in the recording medium; and
a reception step of receiving, from the user, specification of the certain content whose non-referenced parts are to be deleted, where
the non-referenced parts deleted at the deletion step are included in the certain content whose specification has been received at the reception step.

17. The program of claim 16, wherein
a number of contents whose specification is to be received at the reception step is two or more.

18. The program of claim 11, wherein the procedure further comprises:
a reception step of receiving, from the user, an operation for programming a recording; and
a calculation step of calculating an area size required for the programmed recording, where
at the display step, the display is performed only if the calculated area size exceeds a free area size of the recording medium, and at the display step, a message making an inquiry to the user about whether the non-referenced parts should be deleted is further displayed.

19. The program of claim 11, wherein the procedure further comprises:
a reception step of receiving, from the user, specification of an environment setting value, the environment setting value being a minimum free area size that the recording medium should allocate, where
at the display step, the display is performed only if the calculated area size exceeds a free area size of the recording medium, and at the display step, a message making an inquiry to the user about whether the non-referenced parts should be deleted is further displayed.

20. The program of claim 11, wherein the procedure further comprises:
a backup step of recording therein a backup of the non-referenced parts, prior to the deletion performed at the deletion step;
an inquiry step of, after the deletion performed at the deletion step, making an inquiry to the user about whether an undo operation should be performed; and
a write back step of, if the user's answer to the inquiry is affirmative, writing back the backup recorded in the backup unit to the recording medium.

21. A system LSI that performs control with respect to a drive device for a recording medium, the recording medium storing therein at least one video stream, the system LSI comprising:
an editing unit operable to specify, in accordance with a user operation, a plurality of parts of the video stream as playback sections;
a display unit operable to display to the user, a plurality of parts that remain after the playback sections are subtracted from the video stream, as non-referenced parts; and
a deletion unit operable to delete at least one of the displayed non-referenced parts from the recording medium, according to a user operation.

22. The system LSI of claim 21, wherein
each of the playback sections is represented by a set of starting/ending positions of a playback operation, and the plurality of non-referenced parts include a part from a front-end of the video stream to immediately before a starting position of one of the playback sections that appears first, and a part from immediately after an ending position of one of the playback sections that appears last to a rear-end of the video stream.

23. The system LSI of claim 22, wherein
the non-referenced parts include every part immediately after one of the playback sections to immediately before another of the playback sections that follows.

24. The system LSI of claim 21, wherein
the display performed by the display unit is one of: sequential playback of a plurality of pieces of picture data included in the non-referenced parts; and disposing, on a screen, of a plurality of thumbnails each corresponding to the pieces of picture data.

25. The system LSI of claim 21, wherein a plurality of video streams are written to the recording medium, each stream being classified into two or more contents, and the deletion unit deletes only non-referenced parts included in a certain content.

26. The system LSI of claim 25, further comprising:
a list-display unit operable to display a list of the contents in the recording medium; and
a reception unit operable to receive, from the user, specification of the certain content whose non-referenced parts are to be deleted, wherein
the non-referenced parts deleted by the deletion unit are included in the certain content whose specification has been received by the reception unit.

27. The system LSI of claim 26,
a number of contents whose specification is to be received by the reception unit is two or more.

28. The system LSI of claim 21, further comprising:
a reception unit operable to receive, from the user, an operation for programming a recording; and
a calculation unit operable to calculate an area size required for the programmed recording, wherein
the display unit performs the display, only if the calculated area size exceeds a free area size of the recording medium, and the display unit further displays a message making an inquiry to the user about whether the non-referenced parts should be deleted.

29. The system LSI of claim 21, further comprising:
a reception unit operable to receive, from the user, specification of an environment setting value, the environment setting value being a minimum free area size that the recording medium should allocate, wherein
the display unit performs the display, only if the calculated area size exceeds a free area size of the recording medium, and the display unit further displays a message making an inquiry to the user about whether the non-referenced parts should be deleted.

30. The system LSI of claim 21, further comprising:
a backup unit operable to record therein a backup of the non-referenced parts, prior to the deletion performed by the deletion unit;
an inquiry unit operable, after the deletion performed by the deletion unit, to make an inquiry to the user about whether an undo operation should be performed; and
a write back unit operable, if the user's answer to the inquiry is affirmative, to write back the backup recorded in the backup unit to the recording medium.
